(19) United States
(12) Patent Application Publication
(10) Pub. No.: US 2019/0097964 A1
(43) Pub. Date: Mar. 28, 2019

(54) GENERATING ADMINISTRATIVE MESSAGES FOR MESSAGING THREADS INDICATING INTERACTIONS WITH EPHEMERAL CONTENT

(71) Applicant: Facebook, Inc., Menlo Park, CA (US)

(72) Inventors: Peter Henry Martinazzi, Huntington Beach, CA (US); Christian Xavier Dalonzo, Sewell, NJ (US); Shenwei Liu, White Plains, NY (US); Daniel Lee Grech, Sunnyvale, CA (US)

(21) Appl. No.: 15/719,460

(22) Filed: Sep. 28, 2017

(51) Int. Cl. H04L 12/58

(52) U.S. Cl. CPC H04L 51/32; H04L 51/34

(57) ABSTRACT

This disclosure covers methods, non-transitory computer readable media, and systems that provide an administrative message within a messaging thread indicating to a user that a viewer interacted with the user's ephemeral content. By providing the administrative message, the disclosed methods, non-transitory computer readable media, and systems create an indicator for a user within a messaging thread concerning views of (or other interactions with) ephemeral content that the user shared outside of the messaging thread. In some embodiments, for example, the disclosed methods, non-transitory computer readable media, and systems further provide a responsive administrative message to a messaging thread indicating to a user that a viewer responded to the user's ephemeral content item.

### BACKGROUND

Users increasingly share different types of digital content and use different types of communication mediums to share that content with each other within networking systems (e.g., social networking systems and electronic messaging systems). Some users, for example, post digital content on timelines and social feeds accessible to friends, followers, or a select group of users connected through a networking system. Users may also send messages directly to other users or, alternatively, may publicly broadcast a message using a messaging application or other networking application. While some of the digital content may lack a definite expiration, other digital content is short-lived, such as some live-video streams and ephemeral content items that disappear after an expiration period or user-initiated event. Regardless of the digital content's duration or expiration, networking systems currently provide an increasing number of communication mediums for sharing content with other users.

As digital content has proliferated on networking systems, however, tracking and integrating digital content published through different communication mediums has become more complex. A digital image shared through one communication medium may likewise be relevant to—but disconnected from—another communication medium. For example, a user may broadcast a live-video stream using a networking application, but have no indication whether another user viewed the live-video stream when the user interacts with other communication mediums through which the user and other user communicate.

Accordingly, some networking systems lack mechanisms to communicate across communication mediums concerning users' interactions with digital content. The lack of such mechanisms prevents networking systems from integrating information concerning digital content shared through multiple communication mediums and force network users to communicate in one communication medium without useful context from another, related medium for sharing digital content.

### SUMMARY

This disclosure describes one or more embodiments of methods, non-transitory computer readable media, and systems that solve some of the foregoing problems in addition to providing other benefits. While this summary refers to systems for simplicity, the summary also applies to certain disclosed methods and non-transitory computer readable media. To solve these and other problems, the disclosed systems provide an administrative message within a messaging thread indicating to a user that a viewer interacted with a user's ephemeral content shared separate from the messaging thread. By providing the administrative message, the disclosed systems create an indicator for a user within a messaging thread concerning views of (or other interactions with) ephemeral content that the user shared outside of the messaging thread. This additional context triggers and facilitates additional communication within the messaging thread itself and provides an overarching awareness to a user of other users' interactions with the user's shared content across multiple communication mediums.

In some embodiments, for instance, the disclosed systems send an ephemeral content item from a client device to a networking system to add to a user's ephemeral content compilation. After sending the ephemeral content item, the systems receive a read receipt that indicates a viewer viewed the ephemeral content item. At some point, the systems open a messaging thread between the user, the viewer, and (in some cases) additional viewers. After opening the messaging thread, the systems determine that the viewer viewed the ephemeral content item based on the read receipt. In response to that determination, the systems add an administrative message to the messaging thread indicating to the user that the viewer viewed the ephemeral content item.

Similarly, in some embodiments, the disclosed systems receive an ephemeral content item from a first client device. Upon receiving the ephemeral content item, the systems add the ephemeral content item to an ephemeral content compilation for a user. The systems then send the ephemeral content item to a second client device for presentation within a graphical user interface. After sending the ephemeral content item, the systems receive a read receipt (from the second client device) indicating a viewer associated with the second client device viewed the ephemeral content item. In response to receiving the read receipt, the systems cause the client device to add an administrative message to a messaging thread (for the user and the viewer) indicating to the user that the viewer viewed the ephemeral content item.

By providing the administrative message, the disclosed systems provide a signal between communication mediums—from an ephemeral content compilation to a messaging thread—indicating that a viewer has accessed or otherwise interacted with a relevant ephemeral content item. In other words, the disclosed systems integrate information concerning an ephemeral content compilation into a messaging thread. The administrative message thus connects viewers' activity from one digital communication medium to another digital communication medium.

### BRIEF DESCRIPTION OF THE DRAWINGS

The detailed description refers to the drawings briefly described below.

FIGS. 1 illustrates a block diagram of an environment for implementing a networking system in accordance with one or more embodiments.

FIGS. 2A-2B illustrate a sequence-flow diagram of providing an administrative message within a messaging thread indicating to a user that a viewer has interacted with the user's ephemeral content item in accordance with one or more embodiments.

FIGS. 3A-3B illustrate a sequence-flow diagram of providing an administrative message within a group messaging thread indicating to a user that a viewer has interacted with the user's ephemeral content item in accordance with one or more embodiments.

FIGS. 4A-4F illustrate user interfaces of a client device providing administrative messages within a messaging thread indicating to a user that a viewer has interacted with the user's ephemeral content item in accordance with one or more embodiments.

FIGS. 5A-5D illustrate user interfaces of a client device providing administrative messages within a group messaging thread indicating to a user that a viewer has interacted with the user's ephemeral content item in accordance with one or more embodiments.

FIG. 6 illustrates a flowchart of a series of acts in a method of providing an administrative message within a messaging thread indicating to a user that a viewer viewed the user's ephemeral content item in accordance with one or more embodiments.

FIG. 7 illustrates a flowchart of a series of acts in a method of providing an administrative message within a group messaging thread indicating to a user that a viewer viewed the user's ephemeral content item in accordance with one or more embodiments.

FIG. 8 illustrates a flowchart of a series of acts in a method of causing a client device to add an administrative message to a messaging thread indicating to a user that a viewer viewed the user's ephemeral content item in accordance with one or more embodiments.

FIG. 9 illustrates a flowchart of a series of acts in a method of causing a client device to add an administrative message to a group messaging thread indicating to a user that a viewer viewed the user's ephemeral content item in accordance with one or more embodiments.

FIG. 10 illustrates a block diagram of an example computing device in accordance with one or more embodiments.

FIG. 11 illustrates a network environment of a networking system according to one or more embodiments.

FIG. 12 illustrates an example social graph for a networking system in accordance with one or more embodiments.

### DETAILED DESCRIPTION

This disclosure describes one or more embodiments of a networking system that provides an administrative message within a messaging thread indicating to a user that a viewer interacted with the user's ephemeral content. By providing the administrative message, the disclosed networking system creates an indicator for a user within a messaging thread concerning views of (or other interactions with) ephemeral content that the user shared outside of the messaging thread in an ephemeral content compilation.

In some embodiments, for instance, the networking system receives an ephemeral content item from a client device to add to a user's ephemeral content compilation. After receiving the ephemeral content item, the networking system sends a read receipt to the client device that indicates a viewer viewed the ephemeral content item. When the client device opens a messaging thread between the user, the viewer, and (in some cases) additional viewers, the read receipt causes the client device to determine that the viewer viewed the ephemeral content item and then add an administrative message to the messaging thread indicating to the user that the viewer viewed the ephemeral content item. Depending on the embodiment, the messaging thread comprises either a one-on-one messaging thread or a group messaging thread among three or more users.

In certain embodiments, the networking system provides an administrative message only when a viewer has viewed an ephemeral content item last added to an ephemeral content compilation. To ensure that the administrative message reflects a viewing of a last-added ephemeral content item, the networking system compares a timestamp for a viewer's read receipt to a timestamp for the last ephemeral content item added to the ephemeral content compilation. In such embodiments, the networking system provides the administrative message if the timestamp for the viewer's read receipt comes after the timestamp for the last-added ephemeral content item. If the timestamp for the viewer's read receipt comes before the timestamp for the last-added ephemeral content item, however, the networking system optionally does not provide an administrative message indicating that a viewer interacted with an ephemeral content item.

In addition to adding an administrative message to a messaging thread, in some embodiments, the networking system also removes the administrative message based on various triggers. For example, in certain embodiments, the networking system removes the administrative message from the messaging thread (a) when the networking system adds an additional ephemeral content item to the ephemeral content compilation, (b) when the viewer sends a message to the user responding to the ephemeral content item, or (c) when the ephemeral content item expires. Just as ephemeral content items may disappear, an administrative message concerning ephemeral content items may likewise disappear within a messaging thread in response to such triggers.

Beyond indicating that a viewer viewed ephemeral content, an administrative message may also indicate different information concerning a viewer's interaction with an ephemeral content item. For instance, in some embodiments, the networking system receives a message from a viewer responding to the ephemeral content item, such as a comment or emoji responding to the ephemeral content item. Upon receipt of that message, the networking system optionally adds a responsive administrative message to the messaging thread indicating the viewer responded to the ephemeral content item. In some cases, the responsive administrative message includes or refers to a thumbnail of the ephemeral content item.

As the networking system adds administrative messages or responsive administrative messages to a messaging thread, in some embodiments, the networking system adds each administrative message in chronological order based on a timestamp for each administrative message relative to timestamps for other messages within the messaging thread. In other words, in certain embodiments, the networking system adds messages in chronological order according to timestamps, whether the messages come from a user or from the networking system or client device in the form of an administrative message.

As suggested above, the networking system integrates information across communication mediums. Specifically, by using read receipts and administrative messages within messaging threads, the networking system integrates information from an ephemeral content compilation (as one communication medium) into a messaging thread (as another communication medium). While some existing networking systems provide both ephemeral content and digital messaging, some systems lack integration between communication mediums. Accordingly, some existing networking systems that provide users with a messaging application or otherwise provide access to a messaging thread do not provide information concerning the users' ephemeral content items. The disclosed networking system solves this problem by tracking read receipts and providing administrative messages within messaging threads that indicate whether and how viewers interacted with ephemeral content items.

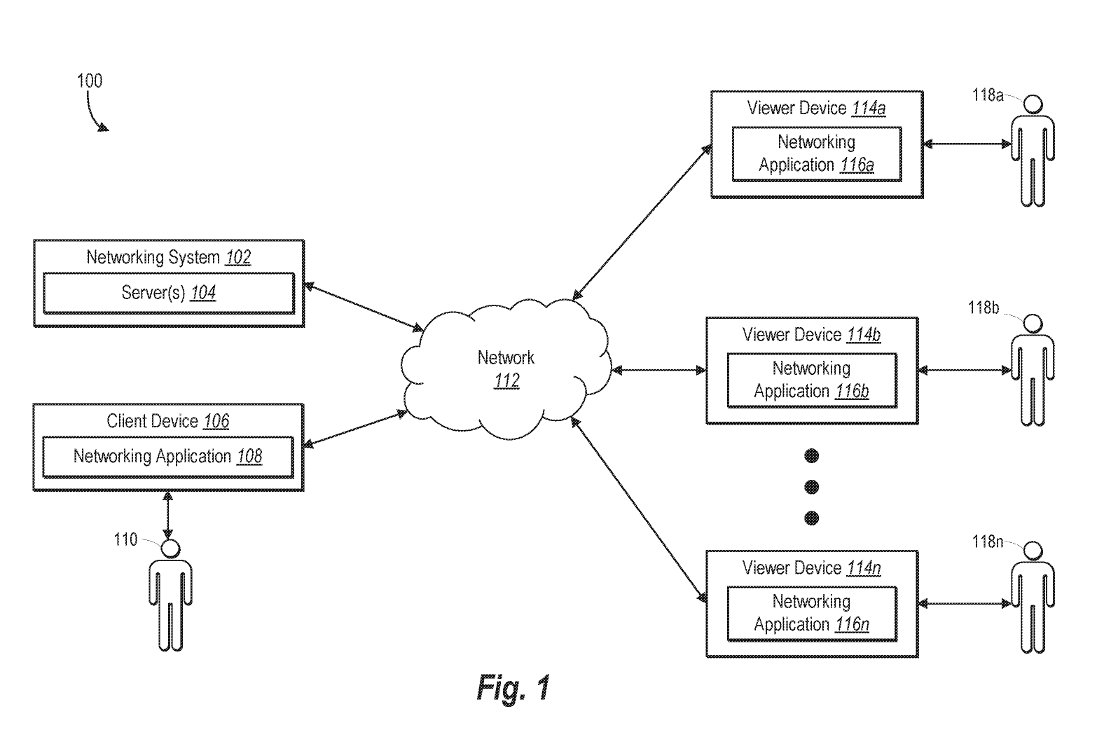

Turning now to the figures, FIG. 1 illustrates a block diagram of one embodiment of a system environment 100 in which a networking system 102 operates. As illustrated in FIG. 1, the system environment 100 includes the networking system 102, including server(s) 104. The system environment 100 further includes a client device 106 and viewer devices 114a-114n. As depicted in FIG. 1, the client device 106 has an associated user 110. Similarly, each of the viewer devices 114a-114n have an associated user—with a user 118a associated with the viewer device 114a, a user 118b associated with the viewer device 114b, and a user 118n associated with the viewer device 114n.

As suggested by FIG. 1, the user 110 sends an ephemeral content item from the client device 106 to the networking system 102 to add to an ephemeral content compilation for the user 110. As used in this disclosure, the term “ephemeral content item” refers to visual content that expires or disappears from view after a user-initiated event or a predetermined time. For example, an ephemeral content item includes a video that expires from an inbox, a timeline, or newsfeed after a viewer has viewed the video once, twice, or some other multiple. As another example, an ephemeral content item includes a digital image that expires from an inbox, a timeline, or newsfeed after a predetermined time period, such as twenty-four hours or ten minutes.

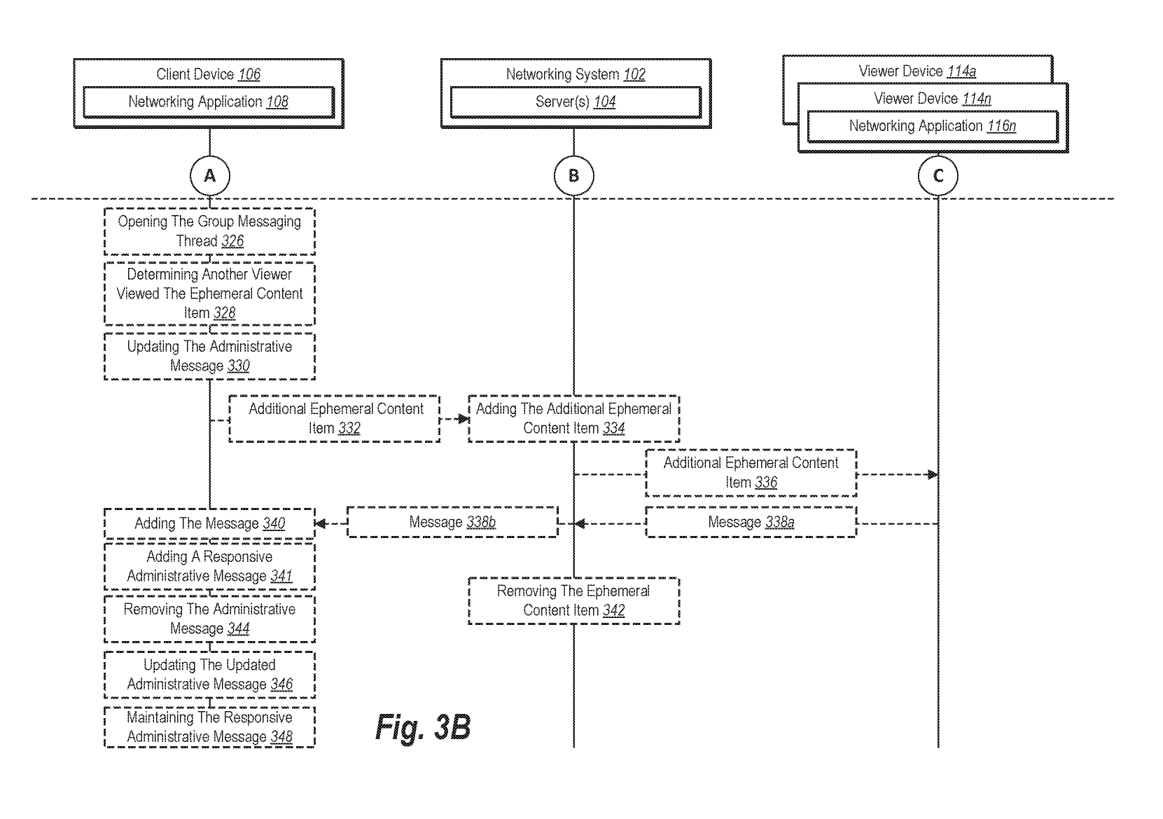

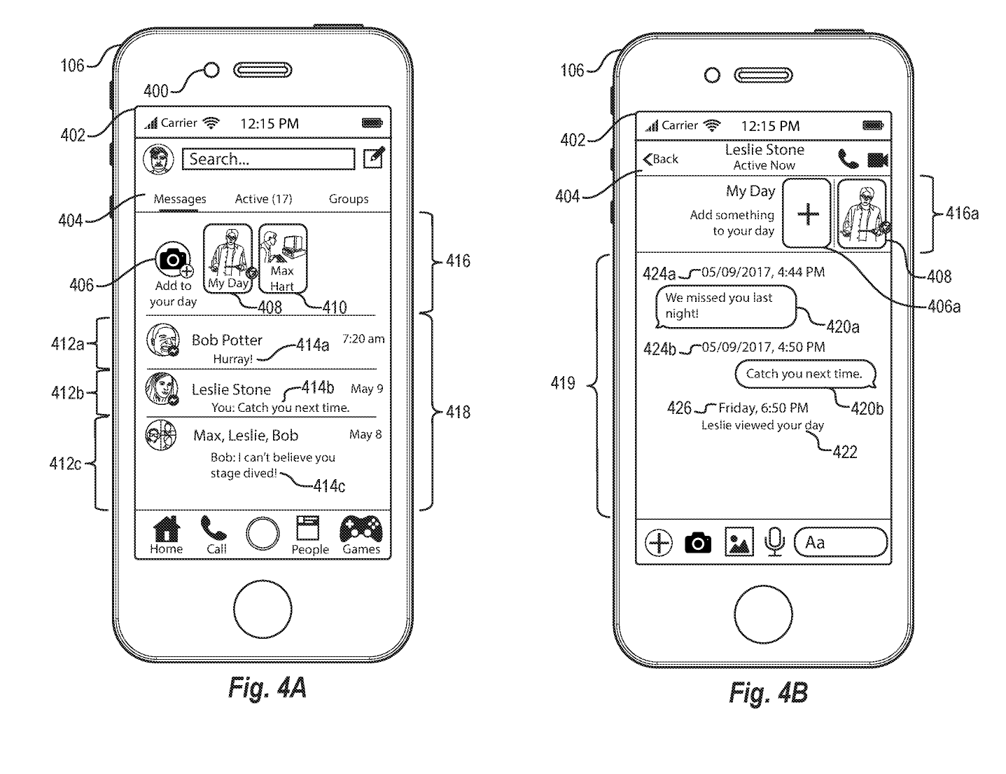

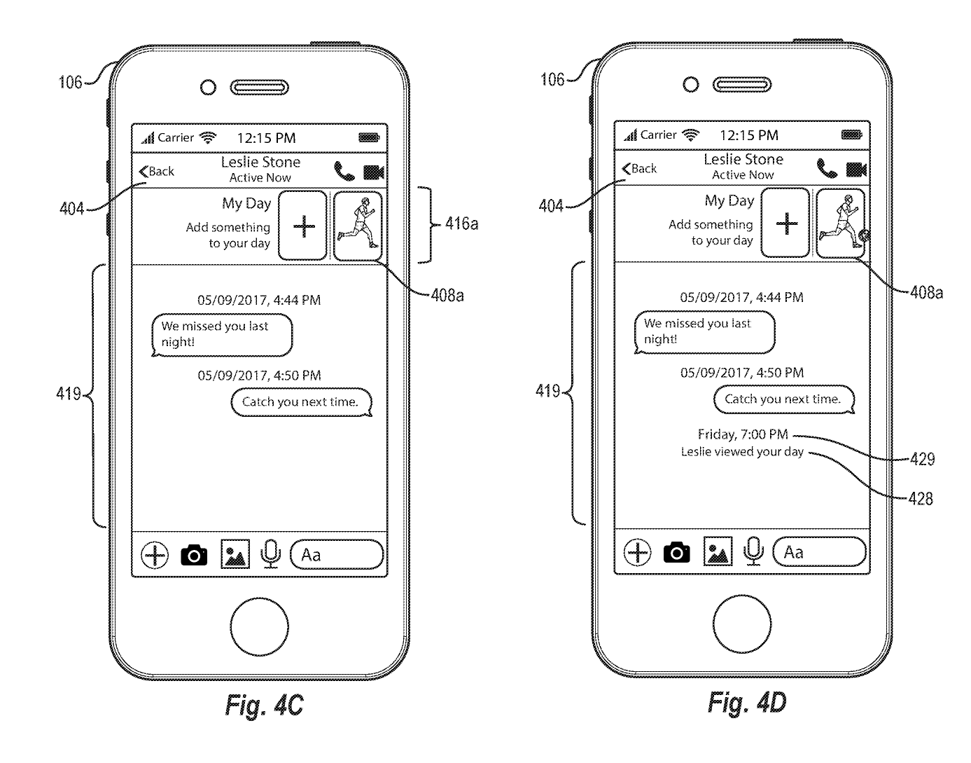

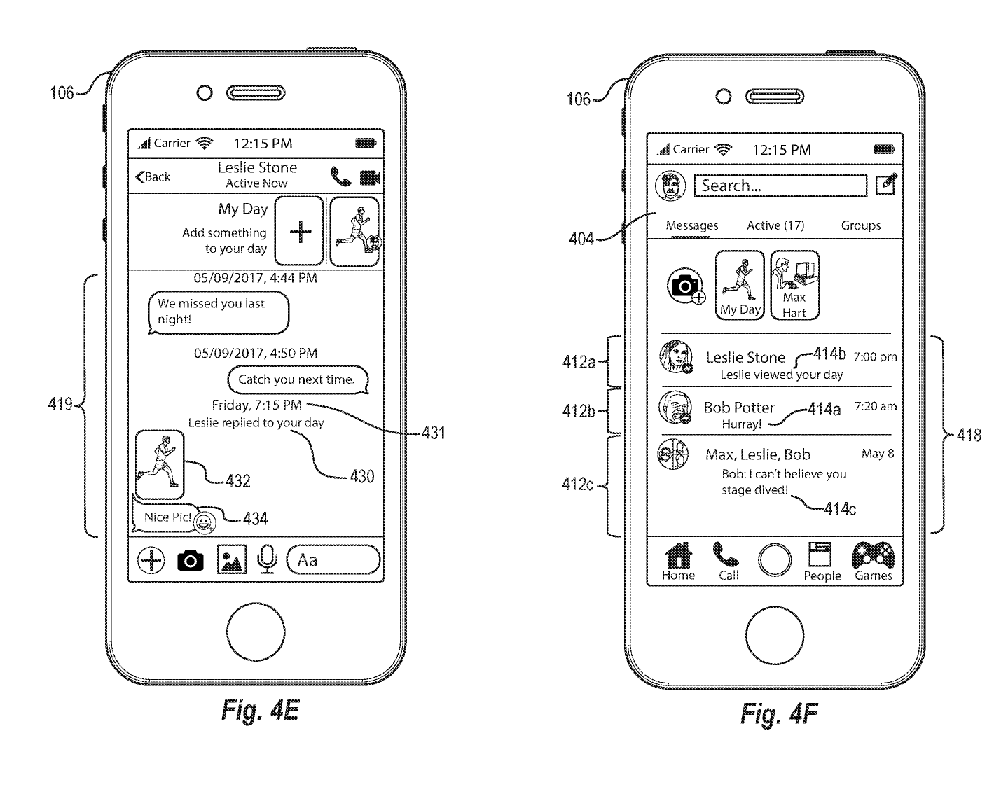

Relatedly, the term “ephemeral content compilation” refers to a collection of one or more ephemeral content items for a user. For example, a networking application may display a feed of an ephemeral content compilation that sequentially shows each ephemeral content item within the compilation. To be clear, an ephemeral content compilation may include a single ephemeral content item at a given time, such as an image or video, depending how many ephemeral content items a user adds to the compilation and how many ephemeral content items have expired. In some embodiments, the networking system 102 provides a separate ephemeral content feed for an ephemeral content compilation within a graphical user interface, as further described below with reference to FIGS. 4A-4F.

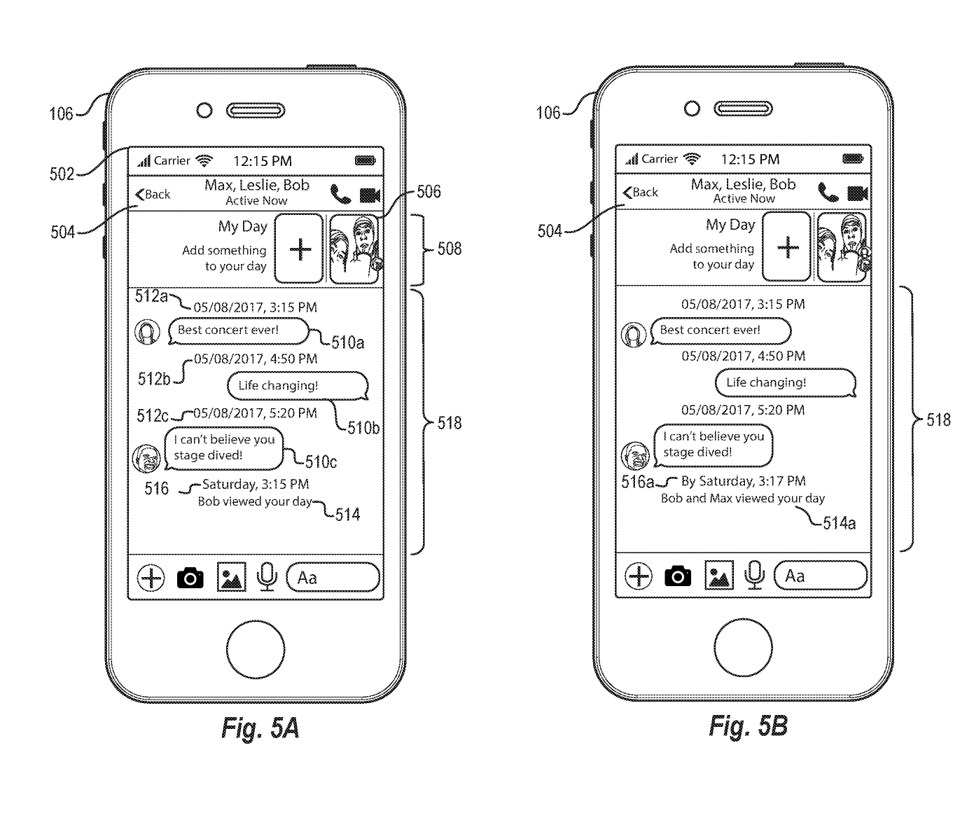

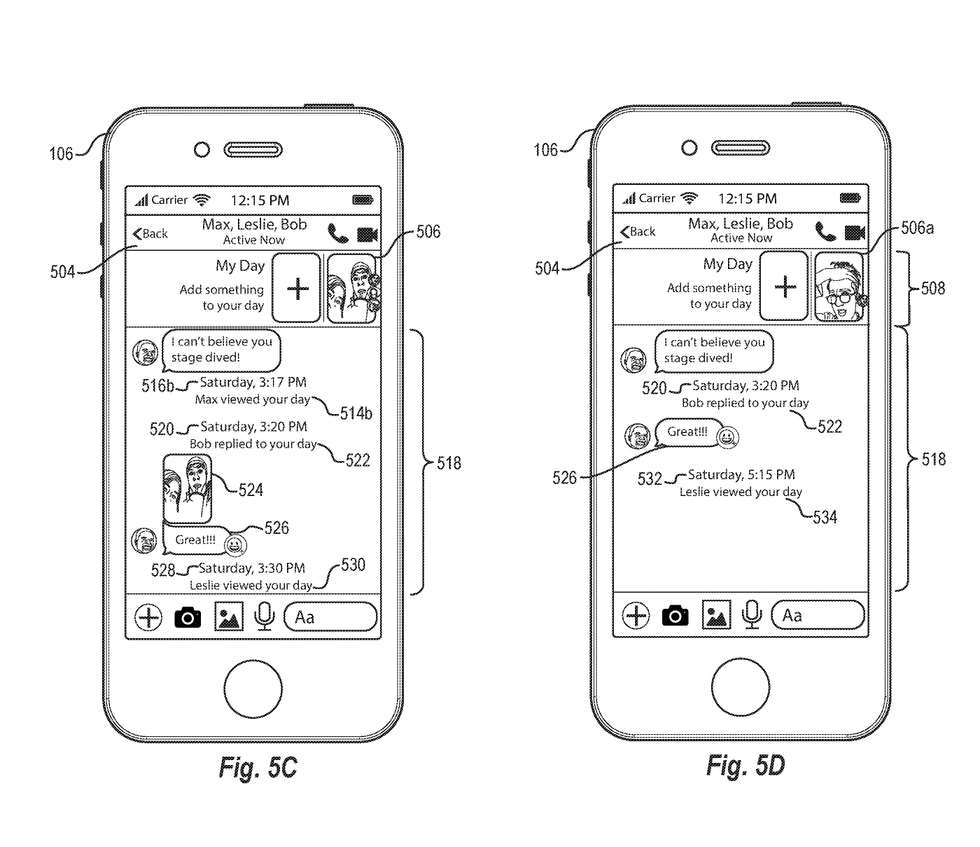

By contrast, the term “messaging thread” refers to a collection of one or more digital messages exchanged between (or among) users of a networking system (e.g., a social networking system and/or electronic messaging system). Accordingly, a messaging thread may include multiple digital messages sent directly between users of the networking system 102. But a messaging thread may likewise include a single digital message sent directly from one user to another user of the networking system 102. In some embodiments, a messaging thread includes a “group messaging thread” comprising a collection of digital messages exchanged among a group of three or more users of the networking system 102. Moreover, in certain embodiments, the client device 106 and the viewer devices 114a-114n present graphical user interfaces that include messaging threads, such as the messaging threads shown in FIGS. 4B-4F and FIGS. 5A-5D described below.

After the networking system 102 adds an ephemeral content item to an ephemeral content compilation, some of the users 118a-118n view the ephemeral content item on their respective viewer devices 114a-114n. Although FIG. 1 illustrates a particular number of viewer devices 114a-114n and a particular number of associated users 118a-118n, the system environment 100 may include any number of client viewer devices and any number of associated users. Any number of these users may view ephemeral content items.

When the viewer device 114a presents the ephemeral content item for the user 118a, for example, the viewer device 114a generates a read receipt. As used in this disclosure, the term “read receipt” refers to a notification indicating that a user viewed particular content. In some embodiments, the viewer devices 114a-114n generate a read receipt based on presenting content within a graphical user interface.

For example, a read receipt may include a notification that a viewer viewed an ephemeral content item—based on the viewer device 114a presenting the ephemeral content item within a graphical user interface. Moreover, in some embodiments, a read receipt includes a timestamp indicating a time at which a user viewed an ephemeral content item and a user identifier that identifies the user associated with a viewer device. While this disclosure often describes read receipts and read-receipt timestamps in terms of a user viewing an ephemeral content item or as indicating a time at which a user viewed an ephemeral content item, in some embodiments, the read receipt and read-receipt timestamp are based on a viewer device presenting the ephemeral content item, rather than an affirmative confirmation from a user that she has read an ephemeral content item.

Continuing the example from above, after generating a read receipt, the viewer device 114a sends the read receipt to the networking system 102. Upon receipt by the networking system 102 of the read receipt, the networking system 102 sends the read receipt to the client device 106 to indicate that the user 118a viewed an ephemeral content item. In response to determining that the user 118a viewed the ephemeral content item, the networking application 108 adds an administrative message to a messaging thread indicating to the user 110 that the user 118a viewed the ephemeral content item.

As used in this disclosure, the term “administrative message” refers to an automatically generated, digital message that describes interaction between one or more users of a networking system and ephemeral content items. For example, in some embodiments, the networking system 102 communicates with the client device 106 to cause the networking application 108 to add an administrative message to a messaging thread indicating that a viewer viewed an ephemeral content item. As noted above, in certain embodiments, the networking system 102 causes the networking application 108 to add a “responsive administrative message” to a messaging thread indicating a viewer responded to an ephemeral content item.

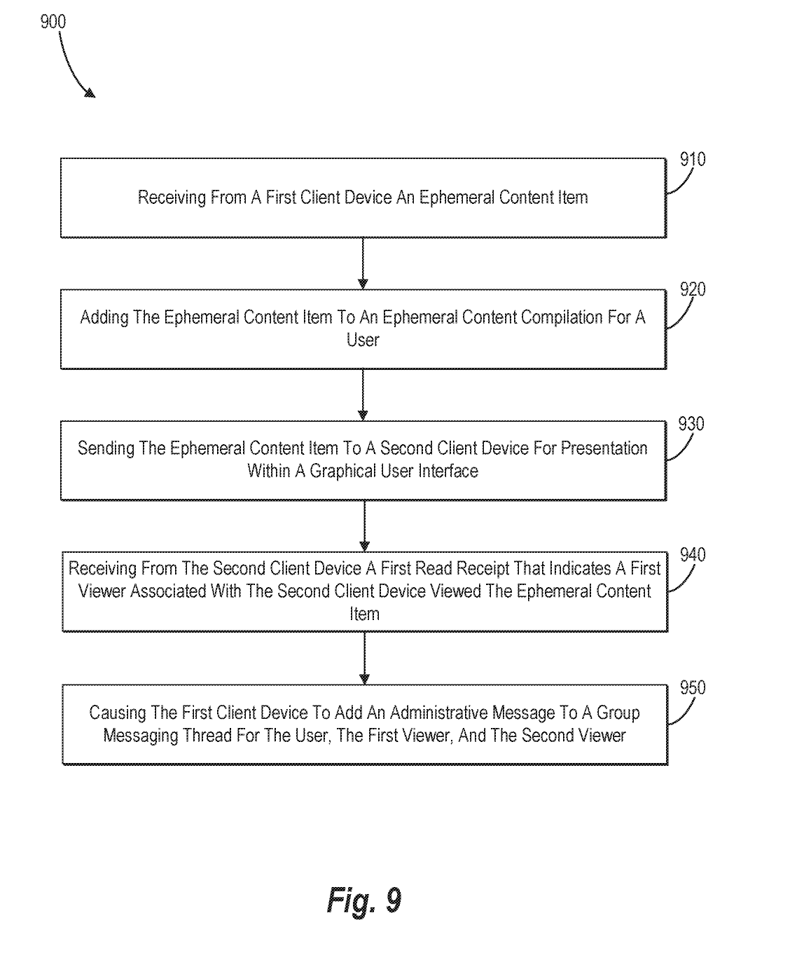

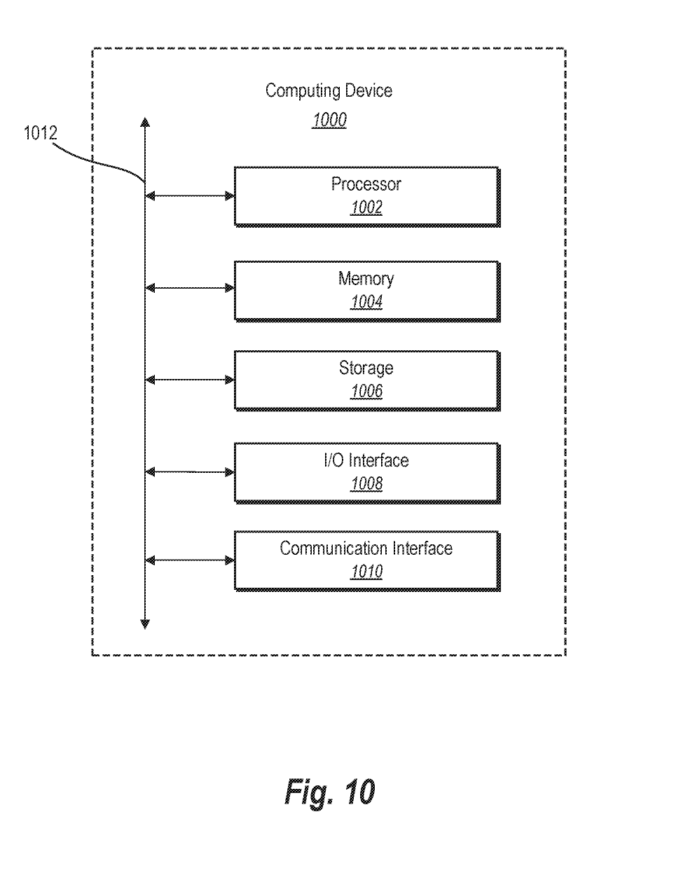

When sending and receiving read receipts, ephemeral content items, or other content, the client device 106 and the viewer devices 114a-114n communicate over a network 112 with the networking system 102, including the server(s) 104. This disclosure describes additional details related to the networking system 102 below with reference to FIGS. 9-10. Additionally, the network 112 may represent a network or a collection of networks, such as the Internet, a corporate intranet, a local area network (“LAN”), or a combination of two or more such networks. The network 112 may also be any suitable network over which the client device 106 and the viewer devices 114a-114n (or other components) access the networking system 102 (or vice versa).

As further shown in FIG. 1, the server(s) 104 can enable the various functions, features, processes, methods, and systems described in this disclosure using, for example, instructions within the networking system 102. Additionally, or alternatively, the server(s) 104 coordinate with the client device 106 and/or the viewer devices 114a-114n to perform or provide the various functions, features, processes, methods, and systems described in more detail below. Although FIG. 1 illustrates a particular arrangement of the networking system 102, server(s) 104, client device 106, network 112, and viewer devices 114a-114n, various additional arrangements are possible. For example, the networking system 102 and the server(s) 104 may directly communicate with the client device 106 and/or the viewer devices 114a-114n and thus bypass the network 112.

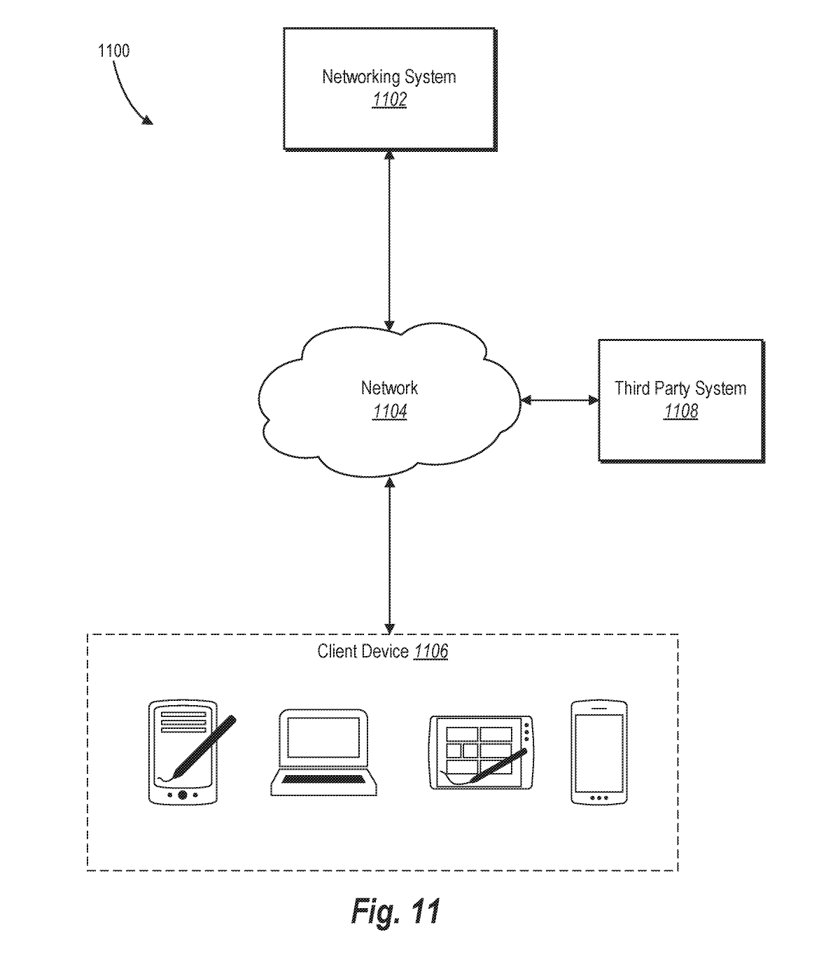

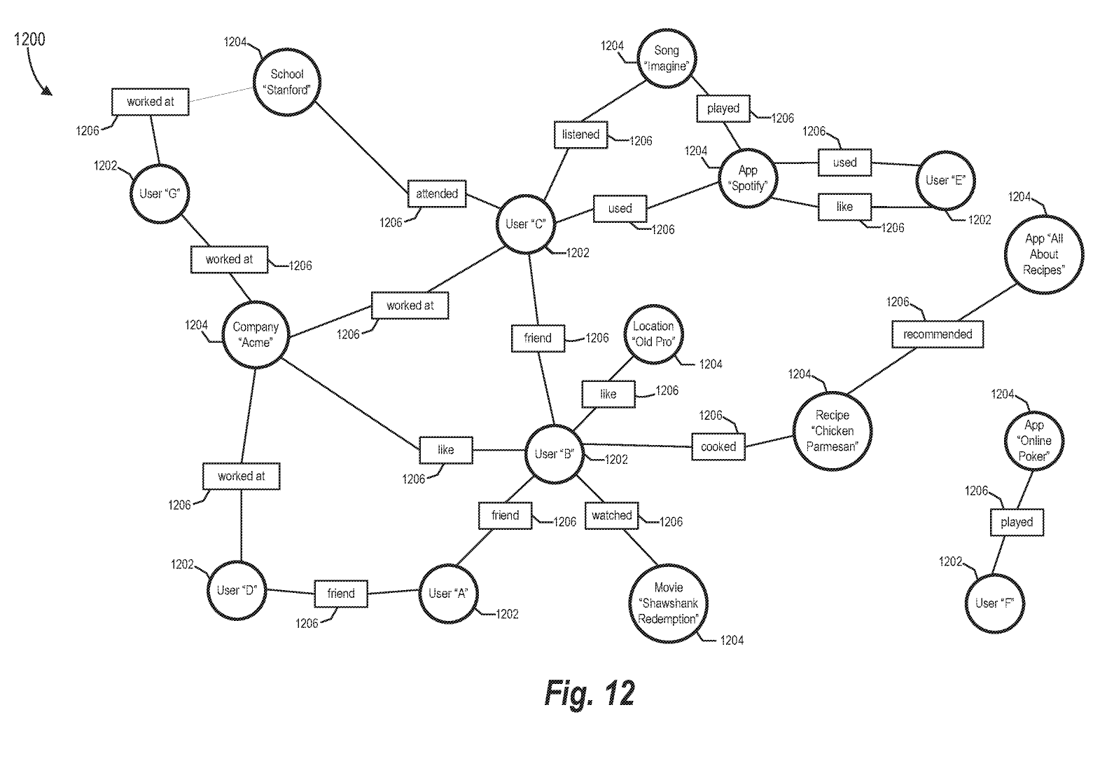

Generally, the client device 106 and viewer devices 114a-114n can include any one of various types of client devices. For example, the client device 106 or viewer devices 114a-114n can include a mobile device (e.g., a smart phone), tablet, laptop computer, desktop computer, television, or any other type of computing device as further explained below with reference to FIG. 10. Similarly, the server(s) 104 can include one or more computing devices including those explained below with reference to FIG. 10. Moreover, the server(s) 104, networking system 102, client device 106, network 112, and viewer devices 114a-114n may communicate using any communication applications and technologies suitable for transporting data and/or communication signals, including any known communication technologies, devices, media, and protocols supportive of data communications, examples of which are described below with reference to FIG. 11.

As an overview of the system environment 100, the server(s) 104 provide the client device 106 and viewer devices 114a-114n access to the networking system 102 through the network 112. In one or more embodiments, when accessing the server(s) 104 of the networking system 102, the client device 106 transmits digitally encoded data to the networking system 102, such as digitally encoded data for an ephemeral content item, message, comment, or read receipt. For example, the networking system 102 may provide a website that enables the user 110 to send digital images or videos that expire after a predetermined time after posting within the networking system 102. By contrast, in one or more embodiments, when the viewer devices 114a-114n access the server(s) 104 of the networking system 102 (e.g., through a website), the viewer devices 114a-114n receive a transmission of digitally encoded data from the networking system 102, such as digitally encoded data for an ephemeral content item, message, comment, or read receipt.

Additionally, or alternatively, the client device 106 and the viewer devices 114a-114n communicate with the server(s) 104 of the networking system 102 via a dedicated application on the client device 106 and the viewer devices 114a-114n. In particular, the client device 106 and the viewer devices 114a-114n each have an associated networking application—with a networking application 108 associated with the client device 106, a networking application 116a associated with the viewer device 114a, a networking application 116b associated with the viewer device 114b, and a networking application 116n associated with the viewer device 114n.

In some embodiments, the networking application 108 and the networking applications 116a-116n comprise web browsers, applets, or other software applications (e.g., native applications) available to the client device 106 and the viewer devices 114a-114n, respectively. In some instances, the networking system 102 provides data packets comprising the networking application 108 or the networking applications 116a-116n to the client device 106 and the viewer devices 114a-114n, respectively (e.g., by providing data to a mobile device that, when executed, creates a software application on the client device 106 and the viewer devices 114a-114n).

The client device 106 may launch the networking application 108 to facilitate interacting with the networking system 102. In some such embodiments, the networking application 108 coordinates communications between the client device 106 and the server(s) 104 such that, for example, the client device 106 sends an ephemeral content item to the networking system 102 (and the networking system 102 in turn sends the ephemeral content item to the viewer devices 114a-114n) or access webpages of the networking system 102.

To facilitate user interaction with the networking system 102, the networking application 108 can comprise one or more graphical user interfaces associated with the networking system 102; receive indications of interactions of the user 110 with the graphical user interfaces; and perform various requests, queries, or responses to other user input, such as opening a messaging thread or displaying an ephemeral content item. Similarly, the networking applications 116a-116n may perform the same functions for the viewer devices 114a-114n (and the users 118a-118n) as the networking application 108 performs for the client device 106 (and the user 110).

For example, the graphical user interfaces of the networking application 108 and networking applications 116a-116n facilitate the transmission of both ephemeral content items and messages for display within a messaging thread. Based on detecting an interaction between the user 110 and a graphical user interface (provided by the client device 106)—such as a selection of an option to record and transmit a digital video with a predetermined expiration—the client device 106 transmits the digital video to the networking system 102 for relay to a viewer or a group of viewers. Upon receiving the digital video, the networking system 102 transmits the digital video to one or more of the viewer devices 114a-114n.

Based on detecting an interaction between the user 118a and a graphical user interface (provided by the viewer device 114a)—such as a selection of an ephemeral content compilation—the viewer device 114a presents one or more ephemeral content items from the compilation within a graphical user interface, such as a series of digital videos with predetermined expiration times. After presenting each ephemeral content item, in some embodiments, the viewer device 114a also transmits a read receipt to the networking system 102. The networking system 102 in turn transmits the read receipt to the client device 106.

Continuing the example, when the client device 106 opens a messaging thread between the user 110 and the user 118a, the networking application 108 causes the client device 106 to determine whether the client device 106 has received a read receipt from the user 118a. Upon determining that the client device 106 received such a read receipt and that the read receipt indicates the user 118a viewed the ephemeral content item, the networking application 108 causes the client device 106 to add an administrative message to the messaging thread indicating to the user 110 that the user 118a viewed the ephemeral content item.

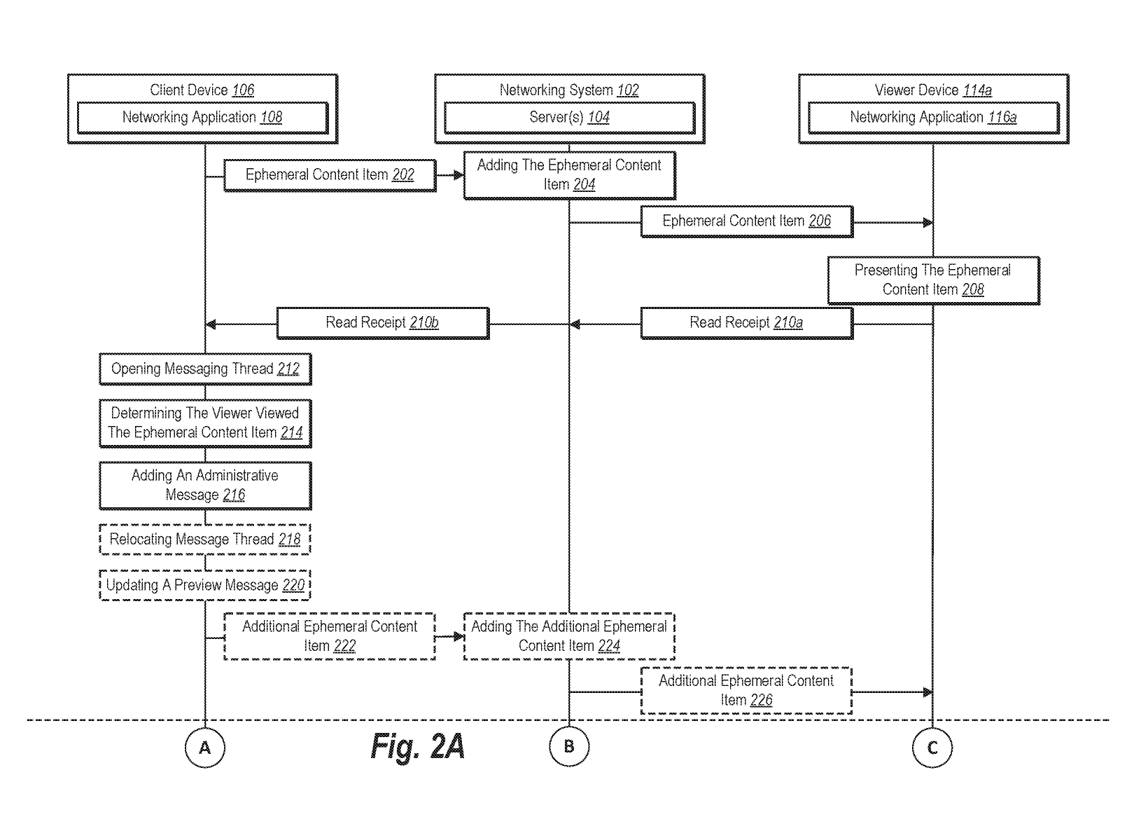

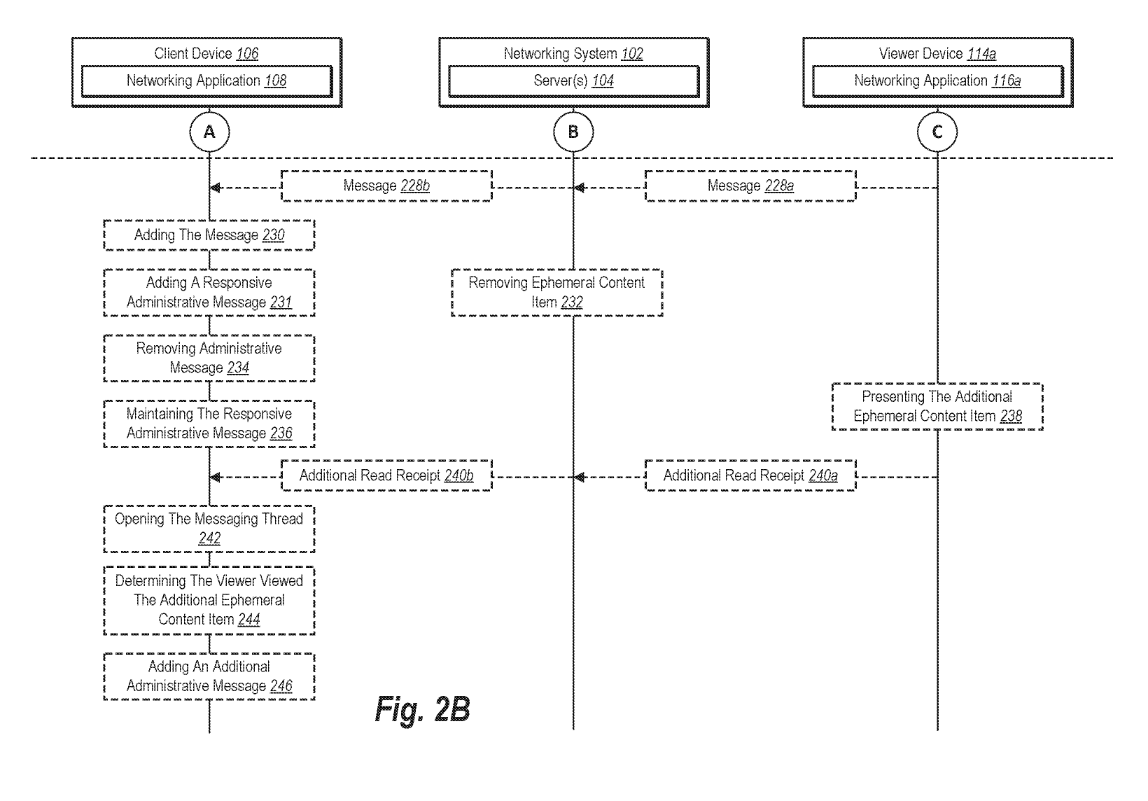

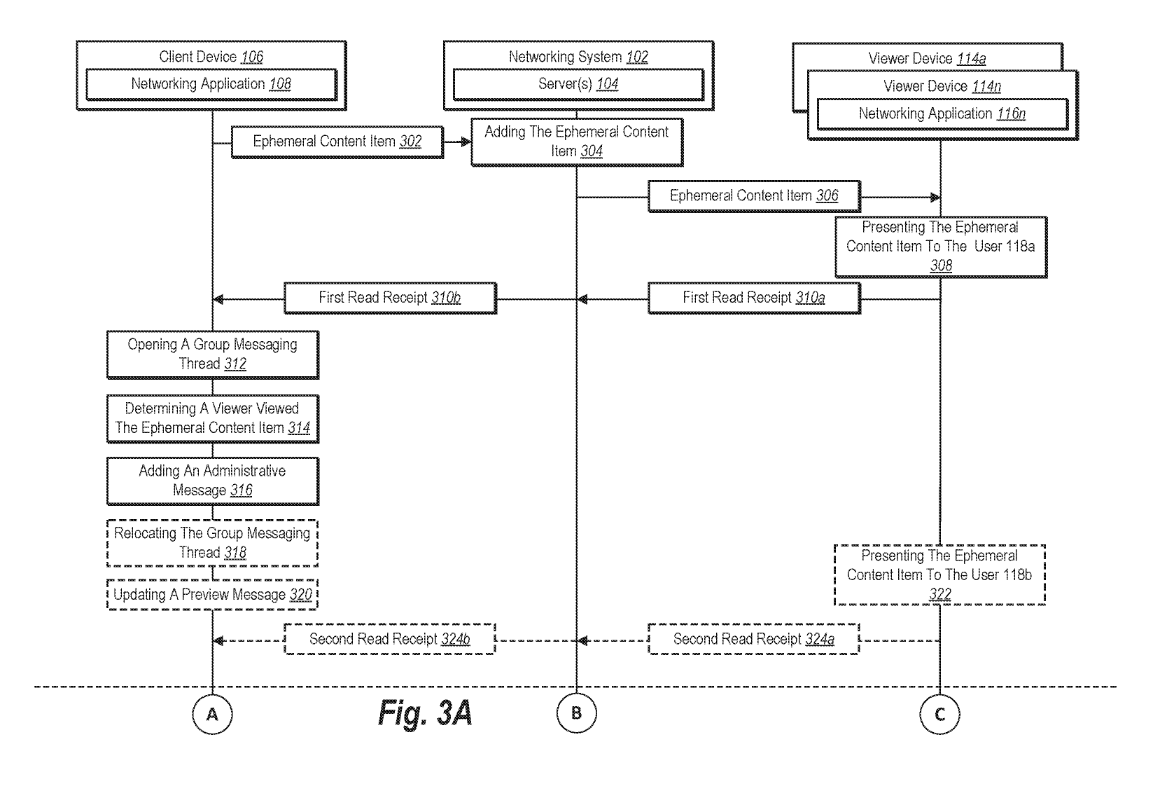

Turning now to FIGS. 2A-2B and FIGS. 3A-3B, these figures provide an overview of embodiments of the networking system 102 that provide an administrative message within a messaging thread indicating to a user that a viewer has interacted with the user's ephemeral content. Specifically, FIGS. 2A-2B illustrate a representation of a sequence of acts 202-246 that the networking system 102, the client device 106, or the viewer device 114a perform, including sending an ephemeral content item to add to an ephemeral content compilation, sending and receiving read receipts, and adding an administrative message to a messaging thread. Similarly, FIGS. 3A-3B illustrate a representation of a sequence of acts 302-348 that the networking system 102, the client device 106, or the viewer devices 114a-114n perform, including sending an ephemeral content item to add to an ephemeral content compilation, sending and receiving read receipts, and adding an administrative message to a group messaging thread. Whereas FIGS. 2A-2B illustrate acts related to a one-on-one messaging thread, FIGS. 3A-3B illustrate acts related to a group messaging thread.

Various components of the system environment 100 perform the acts 202-246 shown in FIGS. 2A-2B or the acts 302-348 shown in FIGS. 3A-3B. In some embodiments, for example, the networking system 102 comprises computer-executable instructions that cause the server(s) 104 to perform one or more of the acts 202-246 or the acts 302-348. Similarly, in certain embodiments, the networking application 108 and the networking applications 116a-116n comprise computer-executable instructions that respectively cause the client device 106 and the viewer devices 114a-114n to perform one or more of the acts 202-246 or the acts 302-348. Rather than repeatedly describe the instructions within the networking system 102 as causing the server(s) 104 to perform certain acts—or the instructions within the networking application 108 or the networking applications 116a-116n as causing the client device 106 or the viewer devices 114a-114n to perform certain acts—this disclosure primarily describes the networking system 102, the client device 106, or the viewer devices 114a-114n as performing the acts 202-246 and the acts 302-348 as a shorthand for those relationships.

Turning back now to FIGS. 2A-2B, as shown in FIG. 2A, the client device 106 performs the act 202 of sending an ephemeral content item to the networking system 102. The networking system 102 in turn performs the act 204 of adding the ephemeral content item to an ephemeral content compilation. For example, in some embodiments, the networking system 102 receives a digital image or digital video from the client device 106 with metadata directing the networking system 102 to add the digital image or digital video to an ephemeral content compilation. In certain embodiments, the networking system 102 includes user settings or default settings that remove an ephemeral content item from the ephemeral content compilation after a predetermined time or after detecting a user-initiated event, such as a user viewing or responding to the ephemeral content item.

Additionally, in some embodiments, when performing the act 202, the client device 106 sends the ephemeral content item and other ephemeral content items for the networking system 102 to add to an ephemeral content compilation. For example, in some such embodiments, the client device 106 sends ephemeral content items serially to the networking system 102 for addition to the ephemeral content compilation. By contrast, in some embodiments, the client device 106 sends multiple ephemeral content items together (e.g., within a data packet) to the networking system 102 for addition to the ephemeral content compilation.

In addition to adding ephemeral content items to an ephemeral content compilation, in some embodiments, the networking system 102 generates a content-item timestamp associated with the ephemeral content item. For example, the networking system 102 optionally generates a content-item timestamp indicating a time at which the networking system 102 receives the ephemeral content item or a time at which the networking system 102 adds the ephemeral content item to the ephemeral content compilation. Although not shown in FIG. 2A, in some embodiments of the act 204, the networking system 102 sends the content-item timestamp with a content-item identifier for the ephemeral content item to the client device 106. As explained below, in certain embodiments, the client device 106 compares the content-item timestamp to a read-receipt timestamp to determine whether to provide an administrative message.

After receiving an ephemeral content item, the networking system 102 distributes that ephemeral content item. As further shown in FIG. 2A, for example, the networking system 102 performs the act 206 of sending the ephemeral content item to the viewer device 114a. The viewer device 114a in turn performs the act 208 of presenting the ephemeral content item. In some embodiments, for instance, the viewer device 114a presents the ephemeral content item as part of an ephemeral content feed for the ephemeral content compilation. When presenting ephemeral content within an ephemeral content feed, the viewer device 114a may present the ephemeral content item serially with other ephemeral content items that are part of the same ephemeral content compilation. As noted above, in some embodiments, the ephemeral content item may be the sole ephemeral content item within the ephemeral content compilation at a given time.

When performing the act 208, the viewer device 114a presents the ephemeral content item in accordance with instructions within the networking application 116a and/or accompanying metadata, either of which may control expiration of the ephemeral content item. For example, in some cases, the networking application 116a (or metadata associated with each ephemeral content item) causes the networking system 102 to remove each ephemeral content item from the ephemeral content compilation (and from view of users) after a predetermined time expires from adding the ephemeral content item to the compilation. Additionally, or alternatively, in other cases, the networking application 116a (or metadata associated with each ephemeral content item) causes the networking system 102 to remove each ephemeral content item from the ephemeral content compilation (and from view of users) after a user-initiated event. For example, the networking system 102 optionally removes an ephemeral content item after the viewer device 114a presents the ephemeral content item for the user 118a to view, after the user 118a responds to the ephemeral content item, or after the viewer device 114a receives an indication of user input with respect to the ephemeral content item, such as saving, posting, emailing, or otherwise transferring the ephemeral content item.

In addition to presenting one or more ephemeral content items, and as further shown in FIG. 2A, the viewer device 114a performs the act 210a of generating and sending a read receipt to the networking system 102. The networking system 102 in turn performs the act 210b of sending the read receipt to the client device 106. In some embodiments, for example, the viewer device 114a generates a read receipt associated with the user 118a after the viewer device 114a presents the ephemeral content item. The read receipt includes information indicating that the user 118a viewed the ephemeral content item. Similarly, in some embodiments, some (or all) of the viewer devices 114b-114n generate and send read receipts indicating that some (or all) of the associated users 118b-118b viewed the ephemeral content item. In such embodiments, the client device 106 receives multiple read receipts from multiple the viewer devices 114a-114n.

As noted above, the read receipt sent from the viewer device 114a and relayed to the client device 106 includes information indicating that the user 118a viewed the ephemeral content item. For example, in some embodiments, the read receipt includes a read-receipt timestamp that indicates a time at which a user viewed the ephemeral content item, as well as a user identifier for the user. Additionally, in some embodiments, the read receipt further includes an ephemeral-content-item identifier that identifies the ephemeral content item presented by a viewer device. Alternatively, the read receipt further includes an ephemeral-content-compilation identifier that identifies the ephemeral content compilation presented by a viewer device.

In some such embodiments, for instance, when the viewer device 114a sends the read receipt (through the networking system 102) to the client device 106, a read-receipt timestamp, user identifier, and ephemeral-content-item identifier provides information for the client device 106 to determine whether the user 118a viewed the ephemeral content item. Similarly, some (or all) of the viewer devices 114b-114n optionally send read receipts that include read-receipt timestamps, user identifiers, and ephemeral-content-item identifiers.

After receiving one or more read receipts from the networking system 102, the client device 106 uses the read receipts to determine whether a user has viewed an ephemeral content item. As further shown in FIG. 2A, the client device 106 performs the act 212 of opening a messaging thread and the act 214 of determining the viewer viewed the ephemeral content item. Specifically, the client device 106 opens a messaging thread between the users 110 and 118a. While the messaging thread could be between the user 110 and any user, for illustrative purposes, this disclosure refers to a messaging thread between the users 110 and 118a with reference to FIGS. 2A-2B. To open a messaging thread, the client device 106 may detect user input selecting the messaging thread from a messaging inbox of the networking application 108. In some embodiments, opening a messaging thread triggers the client device 106 to determine whether the user associated with the messaging thread has viewed the ephemeral content item. FIG. 2A illustrates one such example.

Upon opening a messaging thread between the users 110 and 118a, for example, the client device 106 identifies a user identifier for the user 118a. The client device 106 then compares the user identifier for the user 118a to the user identifiers within read receipts it has received for the ephemeral content item. As shown in FIG. 2A, the client device 106 determines that a user identifier for one of the received read receipts matches the user identifier for the user 118a. By identifying a matching user identifier within a read receipt, the client device 106 determines that the user 118a viewed the ephemeral content item.

As suggested above, in some embodiments, a selection to open a messaging thread triggers the client device 106 to determine whether a user associated with the messaging thread viewed an ephemeral content item. Alternatively, or additionally, in some embodiments, the client device 106 determines whether a particular user viewed an ephemeral content item independent of whether the client device 106 opens a messaging thread associated with the particular user. For example, in some embodiments, upon receiving each read receipt, the client device 106 compares a user identifier within each read receipt to user identifiers for users associated with each messaging thread. Accordingly, the client device 106 can track the viewing status of each user associated with a messaging thread as the client device 106 receives read receipts. As another example, in some embodiments, the client device 106 periodically compares user identifiers for users associated with messaging threads to the user identifiers within read receipts it has received for the ephemeral content item (e.g., by comparing user identifiers every two, five, or ten minutes).

In addition to determining whether a user viewed an ephemeral content item, the client device 106 also adds administrative messages to messaging threads. As shown in FIG. 2A, the client device 106 performs the act 216 of adding an administrative message to a messaging thread. For example, in some embodiments, in response to determining that the user 118a viewed the ephemeral content item, the networking application 108 includes instructions that cause the client device 106 to generate an administrative message indicating that the user 118a viewed the ephemeral content item. The client device 106 then adds the administrative message to the messaging thread (i.e., the messaging thread the client device 106 opened as part of the act 212).

As noted above, in some embodiments, the client device 106 adds an administrative message only when the client device 106 determines that a viewer has viewed the ephemeral content item last added to an ephemeral content compilation. In some circumstances, the administrative message indicates that a viewer has viewed all ephemeral content items currently part of an ephemeral content compilation. Additionally, in some such embodiments, for example, the client device 106 identifies a content-item timestamp that indicates a time at which the networking system 102 added the ephemeral content item to the ephemeral content compilation. The client device 106 then determines whether a read-receipt timestamp associated with a viewer comes before or after the content-item timestamp.

Continuing the example from above, if the read-receipt timestamp comes before the content-item timestamp, the client device 106 does not add an administrative message to the messaging thread. Under these circumstances, the time difference between the read-receipt timestamp and the content-item timestamp indicates the ephemeral content compilation contains one or more ephemeral content items the viewer has not viewed. If the read-receipt timestamp comes after the content-time timestamp, however, the client device 106 adds an administrative message to the messaging thread. Under these circumstances, the time difference between the read-receipt timestamp and the content-item timestamp indicates the viewer has viewed the latest ephemeral content item added to an ephemeral content compilation.

Regardless of the circumstances triggering the client device 106 to add an administrative message, in some embodiments, the client device 106 adds the administrative message to the messaging thread in a chronological order according to timestamp. As noted above, the client device 106 sometimes receives and adds messages from users of the networking system 102 to a messaging thread. When a messaging thread includes one or more messages from such users, the client device 106 optionally adds the administrative message in a chronological order based on a time of the read-receipt timestamp relative to times of timestamps for messages from users within the messaging thread. In such embodiments, the client device 106 presents both messages from users and administrative messages in chronological order according to timestamp.

As illustrated above in FIG. 2A, the client device 106 adds an administrative message to a messaging thread without relocating the messaging thread within a messaging inbox or without updating the messaging thread's preview message. In some embodiments, however, an administrative message triggers the client device 106 to update a messaging thread within a messaging inbox of the networking application 108. As shown in FIG. 2A, for example, the client device 106 optionally performs the act 218 of relocating the messaging thread within a messaging inbox. Upon adding an administrative message to a messaging thread, in some embodiments, for example, the client device 106 relocates the messaging thread atop a messaging inbox of the networking application 108 for better visibility. FIG. 4F below provides an example of relocating a messaging thread.

Additionally, as also shown in FIG. 2A, the client device 106 optionally performs the act 220 of updating the messaging thread's preview message. The term “preview message” refers to a sample message within a messaging thread that a client device presents for the messaging thread in a messaging inbox. In some embodiments, the preview message includes all or part of a most recently received message from a user or a most recently added administrative message within a messaging thread. Accordingly, upon adding an administrative message to a messaging thread, in some embodiments, the client device 106 updates the messaging thread's preview message to include the administrative message. In some such embodiments, the client device 106 both relocates the messaging thread within a messaging inbox and updates the messaging thread's preview message in response to adding an administrative message. FIG. 4A below provides an example of preview messages. FIG. 4F below provides an example of an updated preview message.

When performing the acts 218 or 220, the client device 106 optionally relocates each messaging thread within a messaging inbox and/or updates the messaging thread's preview message in response to adding an administrative message—regardless of the messaging thread's participants or contents. In some embodiments, however, the client device 106 relocates a messaging thread and/or updates the messaging thread's preview message upon adding an administrative message—based on an activity level of the messaging thread or an affinity coefficient between members of the messaging thread. For example, in some embodiments, the client device 106 relocates a messaging thread and/or updates the messaging thread's preview message based on an activity level indicating how often the user 110 adds messages to the messaging thread (e.g., as a threshold number of messages within a time period or as a threshold percentage of messages in comparison to other messaging threads). By contrast, in some embodiments, the client device 106 relocates a messaging thread and/or updates the messaging thread's preview message based on an activity level indicating how often both the user 110 and the user 118a add messages to the messaging thread (e.g., as a threshold number of messages within a time period or as a threshold percentage of messages in comparison to other messaging threads).

As another example, when performing the acts 218 or 220, the client device 106 optionally relocates a messaging thread and/or updates the messaging thread's preview message based on an affinity coefficient between the users 110 and 118a. In such embodiments, an affinity coefficient represents an affinity between two users of the networking system 102—both of which are represented as objects within a social graph. For example, in some such embodiments, the networking system 102 represents each user as a node within a social graph. The networking system 102 also represents connections between the user nodes as edges within the social graph. By using these nodes and edges, the networking system 102 generates an affinity coefficient for each pair of users. Accordingly, in some embodiments, the client device 106 relocates a messaging thread and/or updates the messaging thread's preview message after adding an administrative message to the message thread—only if an affinity coefficient between the users 110 and 118a satisfies or exceeds a particular affinity coefficient (e.g., the affinity coefficient ranks among the highest thirty affinity coefficients between the user 110 and other users). This disclosure further describes affinity coefficients with reference to FIG. 12 below.

As noted above, in some embodiments, the networking system 102 removes an administrative message based on various triggers. FIGS. 2A-2B illustrate three such triggers that optionally cause the client device 106 to remove the administrative message—that is, the networking system 102 adding an additional ephemeral content item to the ephemeral content compilation (referencing the acts 222-226), the user 118a sending a message to the user 110 that responds to the ephemeral content item (referencing the acts 228a-228b and 230), and the networking system 102 removing the ephemeral content item (referencing the act 232). As described below, the client device 106 optionally performs the act 234 of removing the administrative message from the messaging thread in response to one of these three triggers. While any three of these triggers optionally cause the client device 106 to remove the administrative message, the first such trigger to occur is sufficient to cause the client device 106 to remove the administrative message.

As shown in FIG. 2A, for example, the client device 106 optionally performs the act 222 of sending an additional ephemeral content item to the networking system 102. The networking system 102 in turn optionally performs the act 224 of adding the additional ephemeral content item to the ephemeral content compilation and the act 226 of sending the additional ephemeral content item to the viewer device 114a. As suggested by their descriptions in FIG. 2A, the acts 222, 224, and 226 respectively resemble the acts 202, 204, and 206. Accordingly, the description and embodiments set forth above for the acts 202, 204, and 206 respectively apply to the acts 222, 224, and 226—except that the latter acts involve adding an additional ephemeral content item to the same ephemeral content compilation after the client device 106 has added the administrative message to the messaging thread.

In response to the networking system 102 adding the additional ephemeral content item, the client device 106 optionally removes the administrative message from the messaging thread. In such embodiments, the administrative message indicates that the user 118a viewed the ephemeral content item last added to the ephemeral content compilation. After the networking system 102 adds the additional ephemeral content item, the client device 106 removes the administrative message from the messaging thread—because the administrative message no longer accurately reflects that the user 118a viewed the ephemeral content item last added to the ephemeral content compilation.

As shown in FIG. 2B, the viewer device 114a optionally performs the act 228a of sending a message that responds to the ephemeral content item to the networking system 102 to add to the messaging thread. This message may comprise, for example, text, emojis, or digital images responding to the ephemeral content item. The networking system 102 in turn optionally performs the act 228b of sending the message to the client device 106 to add to the messaging thread. Upon receipt of the message, the client device 106 optionally performs the act 230 of adding the message responding to the ephemeral content item to the messaging thread.

When the client device 106 adds the message to the messaging thread, however, the addition of the message triggers the client device 106 to perform the act 234 of removing the administrative message from the messaging thread. If the client device 106 has added a message from the user 118a responding to the ephemeral content item to the messaging thread, the administrative message indicating that the user 118a viewed the ephemeral content item includes unnecessary information. The message responding to the ephemeral content item implies that the user 118a viewed the ephemeral content item. Accordingly, in some embodiments, the client device 106 removes the unnecessary administrative message from the messaging thread.

In addition to adding the message responding to the ephemeral content item, the client device 106 optionally performs the act 231 of adding a responsive administrative message to the messaging thread. For example, the client device 106 optionally adds a responsive administrative message to the messaging thread indicating the user 118a responded to the ephemeral content item. In some such embodiments, the client device 106 adds the responsive administrative message above the message responding to the ephemeral content item. Additionally, in certain embodiments, the responsive administrative message includes or refers to a thumbnail of the ephemeral content item. This thumbnail of the ephemeral content item includes a digital image of (or from) the ephemeral content item. The thumbnail thus indicates the ephemeral content item to which the responsive administrative message refers. FIG. 4E below provides an example of a responsive administrative message.

As further shown in FIG. 2B, the networking system 102 optionally performs the act 232 of removing the ephemeral content item from the ephemeral content compilation. Consistent with the disclosure above, in some embodiments, the networking system 102 removes the ephemeral content item from the ephemeral content compilation (and from the view of users) after a predetermined time expires (e.g., twenty-four hours, ten minutes). Alternatively, the networking system 102 removes the ephemeral content item from the ephemeral content compilation (and from the view of users) after receiving an indication of a user-initiated event (e.g., an indication that the user 118a views, saves, posts, emails, or otherwise transfers the ephemeral content item).

In some embodiments, the networking system 102 removes the ephemeral content item from the ephemeral content compilation with respect to a single user based on a user-initiated event, but leaves the ephemeral content item within the ephemeral content compilation for the other users who have not performed the user-initiated event. For example, the networking system 102 optionally removes the ephemeral content item from the ephemeral content compilation available to the user 118a after the viewer device 114a presents the ephemeral content item to the user 118a. But the networking system 102 leaves the ephemeral content item within the ephemeral content compilation available to other users whose viewer devices have yet to present the ephemeral content item.

After the networking system 102 performs the act 232, the client device 106 determines that the networking system 102 has removed the ephemeral content item. The client device 106 either determines the ephemeral content item has been removed based on a predetermined time expiring or, alternatively, based on a notification from the networking system 102 that the predetermined time has expired or that a user-initiated event has occurred. In response to the networking system 102 removing the ephemeral content item from the ephemeral content compilation, the client device 106 performs the act 234 of removing the administrative message from the messaging thread.

In contrast to removing the administrative message from the messaging thread, in some embodiments, the client device 106 does not do the same to the responsive administrative message. As further shown in FIG. 2B, the client device 106 optionally performs the act 236 of maintaining the responsive administrative message within the messaging thread. In response to the networking system 102 removing the ephemeral content item from the ephemeral content compilation, however, the client device 106 nevertheless optionally removes any thumbnail of the ephemeral content item included within or referred to by the responsive administrative message. In such embodiments, the client device 106 ensures that the thumbnail of the ephemeral content item is removed when the ephemeral content item itself is removed from the ephemeral content compilation.

As noted above, the client device 106 optionally sends an additional ephemeral content item to the networking system 102 to add to the ephemeral content compilation. If the user 118a views this additional ephemeral content item—even after the administrative message has been removed—the client device 106 optionally adds an additional administrative message indicating that the user 118a viewed the additional ephemeral content item. The following acts 238-246 represent that process of adding an additional administrative message.

As shown in FIG. 2B, the viewer device 114a optionally performs the act 238 of presenting the additional ephemeral content item and the act 240a of sending the additional read receipt to the networking system 102. The networking system 102 in turn optionally performs the act 240b of sending the additional read receipt to the client device 106. After receiving the additional read receipt, the client device 106 optionally performs the act 242 of opening the messaging thread, the act 244 of determining the viewer viewed the additional ephemeral content item, and the act 246 of adding an additional administrative message. As suggested by their descriptions in FIGS. 2A-2B, the acts 238, 240a, 240b, 242, 244, and 246 respectively resemble the acts 208, 210a, 210b, 212, 214, and 216. Accordingly, the description and embodiments set forth above for the acts 208, 210a, 210b, 212, 214, and 216 respectively apply to the acts 238, 240a, 240b, 242, 244, and 246. In contrast to the acts 208, 210a, and 210b, however, the acts 238, 240a, and 240b involve the viewer device 114a presenting the additional ephemeral content item, and the viewer device 114a and the networking system 102 sending an additional read receipt that corresponds to the additional ephemeral content item. In contrast to the acts 212, 214, and 216, the acts 242, 244, and 246 involve the client device 106 determining that the user 118a viewed the additional ephemeral content item based on the additional read receipt and adding an additional administrative message to the messaging thread indicating to the user 110 that the user 118a viewed the additional ephemeral content item. As above, in some circumstances, the administrative message indicates that the user 118a has viewed all ephemeral content items currently part of an ephemeral content compilation for the user 110.

Turning back now to FIGS. 3A-3B, as noted above, these figures illustrate acts related to a group messaging thread. As shown in FIG. 3A, the client device 106 performs the act 302 of sending an ephemeral content item to the networking system 102. The networking system 102 in turn performs the act 304 of adding the ephemeral content item to an ephemeral content compilation. After adding the ephemeral content item, the networking system 102 performs the act 306 of sending the ephemeral content item to one or more of the viewer devices 114a-114n. At this point in FIG. 3A, any one of the viewer devices 114a-114n may present the ephemeral content item within a graphical user interface and send a read receipt to the client device 106. For ease of illustration, however, this disclosure describes the viewer device 114a presenting the ephemeral content item based on receiving user input. Accordingly, as shown in FIG. 3A, the viewer device 114a performs the act 308 of presenting the ephemeral content item to the user 118a.

As further shown in FIG. 3A, the viewer device 114a also performs the act 310a of generating and sending a first read receipt to the networking system 102. The networking system 102 in turn performs the act 310b of sending the first read receipt to the client device 106. After receiving the first read receipt, the client device 106 performs the act 312 of opening a group messaging thread, the act 314 of determining a viewer viewed the ephemeral content item, and the act 314 of adding an administrative message to the group messaging thread.

As indicated by FIG. 3A, the group messaging thread comprises multiple users as participants, such as a group messaging thread among the users 110, 118a, and 118b. Because the networking system 102 sends the ephemeral content item to the viewer devices 114a and 114b, either the user 118a or the user 118b could have initially viewed the ephemeral content item before the other user. As indicated above, for illustrative purposes, the first read receipt shown in FIG. 3A corresponds to the user 118a associated with the viewer device 114a. Accordingly, when performing the acts 314 and 316, the client device 106 determines that the user 118a viewed the ephemeral content item—based on the first read receipt—and adds an administrative message to the group messaging thread indicating that the user 118a viewed the ephemeral content item. In some circumstances, the administrative message indicates that the user 118a has viewed all ephemeral content items currently part of an ephemeral content compilation for the user 110.

As suggested by their descriptions in FIGS. 2A and 3A, the acts 302, 304, 306, 308, 310a, 310b, 312, 314, and 316 respectively resemble the acts 202, 204, 206, 208, 210a, 210b, 212, 214, and 216. Accordingly, the description and embodiments set forth above for the acts 202, 204, 206, 208, 210a, 210b, 212, 214, and 216 respectively apply to the acts 302, 304, 306, 308, 310a, 310b, 312, 314, and 316—except that the latter acts involve a group messaging thread (not a one-on-one messaging thread) and multiple viewer devices that may present the ephemeral content item and send a read receipt. In contrast to the acts 212 and 216 in FIG. 2A, the acts 312 and 316 in FIG. 3A involve the client device 106 opening a group messaging thread among the users 110, 118a, and 118b, and adding the administrative message to the group messaging thread indicating to the user 110 that the user 118a viewed the ephemeral content item.

As further shown in FIG. 3A, the client device 106 optionally performs the act 318 of relocating the group messaging thread within a messaging inbox and the act 320 of updating a preview message of the group messaging thread. As suggested by their descriptions in FIGS. 2A and 3A, the acts 318 and 320 respectively resemble the acts 218 and 220. Accordingly, the description and embodiments set forth above for the acts 218 and 220 respectively apply to the acts 318 and 320—except that the latter acts involve the client device 106 relocating a group messaging thread (not a one-on-one messaging thread) within a messaging inbox and updating a preview message of the group messaging thread (not a one-on-one messaging thread).

As above, in some embodiments of the acts 318 and 320, the client device 106 relocates a group messaging thread and/or updates the group messaging thread's preview message upon adding an administrative message—based on an activity level of the group messaging thread or an affinity coefficient among members of the group messaging thread. In contrast to embodiments that involve a one-on-one messaging thread, however, the affinity coefficients used for a group messaging thread may involve relying on an affinity coefficient between one or more users of the group messaging thread.

For example, when performing the acts 318 or 320, the client device 106 optionally relocates a group messaging thread and/or updates the group messaging thread's preview message based an affinity coefficient between the users 110 and 118a, on the one hand, or an affinity coefficient between the users 110 and 118b, on the other hand. In some embodiments, the client device 106 relocates a group messaging thread and/or updates the group messaging thread's preview message after adding an administrative message to the group message thread only if the affinity coefficient between the users 110 and 118b—or the affinity coefficient between the users 110 and 118b—satisfies or exceeds a particular affinity coefficient (e.g., one of the two affinity coefficients ranks among the highest thirty affinity coefficients between the user 110 and other users).

As suggested above, in addition to adding an administrative message to a group messaging thread, in some embodiments, the client device 106 updates the administrative message to reflect when additional viewers from among the group messaging thread have viewed the ephemeral content item. As shown in FIG. 3A, for example, the viewer device 114b performs the act 322 of presenting the ephemeral content item to the user 118b and the act 324a of generating and sending a second read receipt to the networking system 102. The networking system 102 in turn performs the act 310b of sending the second read receipt to the client device 106.

In contrast to the first read receipt, however, the second read receipt indicates that the user 118b, not the user 118a, viewed the ephemeral content item. For example, in some embodiments, the first read receipt includes a first read-receipt timestamp, a first user identifier, and a first ephemeral-content-item identifier—each of which are associated with the viewer device 114a presenting the ephemeral content item to the user 118a. Similarly, in this particular embodiment, the second read receipt includes a second read-receipt timestamp, a second user identifier, and a second ephemeral-content-item identifier—each of which are associated with the viewer device 114b presenting the ephemeral content item to the user 118b. In such embodiments, the user identifiers identify which user viewed the ephemeral content item to the client device 106.

After receiving the second read receipt, the client device 106 performs the act 326 of opening the group messaging thread and the act 328 of determining another viewer viewed the ephemeral content item. Specifically, the client device 106 determines that the user 118b viewed the ephemeral content item based on the second read receipt. For example, the client device 106 may determine that a user identifier for the user 118b matches the user identifier within the second read receipt. As suggested by their descriptions in FIGS. 2A and 3A-3B, the acts 322, 324a, 324b, 326, and 328 respectively resemble the acts 208, 210a, 210b, 212, and 214. Accordingly, the description and embodiments set forth above for the acts 208, 210a, 210b, 212, and 214 respectively apply to the acts 322, 324a, 324b, 326, and 328—except that the latter acts involve a group messaging thread (not a one-on-one messaging thread) and an additional viewer corresponding to the second read receipt (not a single viewer part of the one-on-one messaging thread).

After determining that the user 118b viewed the ephemeral content item, the client device 106 performs the act 330 of updating the administrative message for the group messaging thread. For example, in some embodiments, the client device 106 updates the administrative message to indicate that—not only the user 118a—but the user 118b also viewed the ephemeral content item. In some embodiments, for example, the client device 106 updates the administrative message by adding a separate entry from the user 118b indicating that the user 118b viewed the ephemeral content item. Alternatively, in other embodiments, the client device 106 updates the administrative message by modifying the administrative message to indicate that the user 118a and the user 118b viewed the ephemeral content item by a certain time.

Although the examples above describe updating the administrative message to refer to two users, the networking system 102 includes embodiments with group messaging threads for more than two users. Accordingly, the client device 106 optionally updates the administrative message to indicate that additional users of the networking system 102 viewed the ephemeral content item depending on the number of read receipts received by the client device 106. FIG. 5B below illustrates an example of an updated administrative message.

Similar to certain embodiments involving a one-on-one messaging thread, the networking system 102 also optionally performs the act 344 of removing the administrative message from the group messaging thread based on various triggers. FIG. 3B illustrates three such triggers that optionally cause the client device to remove the administrative message from the group messaging thread—that is, the networking system 102 adding an additional ephemeral content item to the ephemeral content compilation (referencing the acts 332-336), the user 118a or the user 118b sending a message to the user 110 responding to the ephemeral content item (referencing the acts 338a-338b and 340), and the networking system 102 removing the ephemeral content item (referencing the act 342).

Similarly, the client device 106 also optionally performs the act 346 of updating the administrative message for the group messaging thread in response to either the user 118a or the user 118b sending a message to the user 110 responding to the ephemeral content item. While any three of the triggers described above optionally cause the client device 106 to remove or update the administrative message, the first such trigger to occur is sufficient to cause the client device 106 to remove or (in some instances) update the administrative message.

As shown in FIG. 3A, for example, the client device 106 optionally performs the act 332 of sending an additional ephemeral content item to the networking system 102. The networking system 102 in turn optionally performs the act 334 of adding the additional ephemeral content item to the ephemeral content compilation and the act 336 of sending the additional ephemeral content item to the viewer devices 114a-114n. As suggested by their descriptions in FIGS. 2A and 3B, the acts 332, 334, and 336 respectively resemble the acts 202, 204, and 206. Accordingly, the description and embodiments set forth above for the acts 202, 204, and 206 respectively apply to the acts 332, 334, and 336—except that the latter acts involve adding an additional ephemeral content item to the same ephemeral content compilation after the client device 106 adds the administrative message to—or updates the administrative message for—the group messaging thread.

In response to the networking system 102 adding the additional ephemeral content item to the ephemeral content compilation, the client device 106 optionally removes the administrative message from the group messaging thread. As noted above, in some embodiments, the administrative message indicates that the user 118a viewed the ephemeral content item last added to the ephemeral content compilation. By contrast, in some embodiments, an updated administrative message indicates that both the users 118a and 118b viewed the ephemeral content item last added to the ephemeral content compilation. After the networking system 102 adds the additional ephemeral content item, the client device 106 removes the administrative message or the updated administrative message from the group messaging thread—because neither the administrative message nor the updated administrative message accurately reflect that the user 118a and/or the user 118b viewed the ephemeral content item last added to the ephemeral content compilation.

As further shown in FIG. 3B, the viewer device 114a and/or the viewer device 114b optionally perform the act 338a of sending a message that responds to the ephemeral content item to the networking system 102 to add to the group messaging thread. In other words, the viewer devices 114a and 114b may collectively send a single or multiple messages responding to the ephemeral content item. The networking system 102 in turn optionally performs the act 338b of sending the message (or messages) to the client device 106 to add to the group messaging thread. Upon receipt of the message (or messages), the client device 106 optionally performs the act 340 of adding the message (or messages) responding to the ephemeral content item to the group messaging thread.

As indicated by FIG. 3B, adding either a single message or multiple messages responding to the ephemeral content item triggers the client device 106 to perform different acts. When the client device 106 adds a message to the group messaging thread from each of the viewers within the group messaging group responding to the ephemeral content item, the client device 106 removes the administrative message or the updated administrative message from the group messaging thread. By contrast, when the client device 106 adds a message to the group messaging thread from only some (but not all) of the viewers within the group messaging group responding to the ephemeral content item, the client device 106 updates the updated administrative message to eliminate unnecessary information concerning which viewers viewed the ephemeral content item.

For example, when the client device 106 adds messages from both the viewer devices 114a and 114b to the group messaging thread—and the group messaging thread includes only the users 110, 118a, and 118b—the addition of the last message triggers the client device 106 to perform the act 344 of removing the administrative message from the group messaging thread. If the client device 106 has added messages from both the user 118a and 118b responding to the ephemeral content item to the group messaging thread, an administrative message indicating that the user 118a and/or the user 118b viewed the ephemeral content item includes unnecessary information. As noted above, messages from the users 118a and 118b responding to the ephemeral content item imply that the users 118a and 118b viewed the ephemeral content item. Accordingly, in some embodiments, the client device 106 removes the unnecessary administrative message from the group messaging thread.

By contrast, when the client device 106 adds a single message from either the viewer device 114a or the viewer device 114b (but not from both) to the group messaging thread—and the group messaging thread includes only the users 110, 118a, and 118b—the addition of the single message triggers the client device 106 to perform the act 346 of updating the updated administrative message for the group messaging thread. A message from the user 118a or 118b responding to the ephemeral content item implies that the user 118a or 118b viewed the ephemeral content item. Accordingly, in some embodiments, the client device 106 updates the updated administrative message by removing the unnecessary information from the updated administrative message. In other words, the client device 106 removes information indicating that the user 118a viewed the ephemeral content item—if the user 118a sent the message—or removes information indication that the user 118b viewed the ephemeral content item—if the user 118b sent the message.

As noted above and as further shown in FIG. 3B, the client device 106 optionally adds the message (or messages) responding to the ephemeral content item to the group messaging thread. In addition to adding the message (or messages), in some embodiments, the client device 106 optionally performs the act 341 of adding a responsive administrative message to the group messaging thread. For example, the client device 106 may add a responsive administrative message to the group messaging thread indicating that either the user 118a or the user 118b (or both) responded to the ephemeral content item.

FIG. 3B illustrates an additional trigger for removing an administrative message the networking system 102 optionally performing the act 342 of removing the ephemeral content item from the ephemeral content compilation. Consistent with the disclosure above, the networking system 102 optionally removes the ephemeral content item from the ephemeral content compilation (and from the view of users) after a predetermined time expires (e.g., twenty-four hours, ten minutes) or after receiving an indication of a user-initiated event (e.g., an indication that the user 118a or the user 118b views, saves, posts, emails, or otherwise transfers the ephemeral content item). In response to the networking system 102 removing the ephemeral content item from the ephemeral content compilation, the client device 106 performs the act 344 of removing the administrative message from the group messaging thread. Similarly, when the administrative message has been updated to become an update administrative message—and the networking system 102 removes the ephemeral content item from the ephemeral content compilation—the client device 106 likewise removes the updated administrative message from the group messaging thread.

In contrast to removing the administrative message or the updated administrative message from the group messaging thread, in some embodiments, the client device 106 does not do the same to a responsive administrative message. As shown in FIG. 3B, the client device 106 optionally performs the act 348 of maintaining the responsive administrative message within the group messaging thread. FIG. 5D below provides an example of the client device 106 maintaining a responsive administrative message within a group messaging thread.

As suggested by their descriptions in FIGS. 2B and 3B, the acts 341, 342, 344, and 348 respectfully resemble the acts 231, 232, 234, and 236. Accordingly, the description and embodiments set forth above for the acts 231, 232, 234, and 236 respectfully apply to the acts 341, 342, 344, and 348. In contrast to the act 231, however, the act 341 involves adding a responsive administrative message to the group messaging thread indicating that either the user 118a or the user 118b responded to the ephemeral content item. In contrast to the acts 232, 234, and 236, the acts 342, 344, and 348 involve removing an ephemeral content item from an ephemeral content compilation viewed by multiple viewers within a group messaging thread (not a one-on-one messaging thread), removing an administrative message or updated administrative message from a group messaging thread (not a one-on-one messaging thread), and maintaining a responsive administrative message within a group messaging thread (not a one-on-one messaging thread).

In addition to removing or updating administrative messages, the client device 106 optionally sends an additional ephemeral content item to the networking system 102 to add to the ephemeral content compilation. If one of the users from the group messaging thread views this additional ephemeral content item, the client device 106 optionally adds an additional administrative message indicating that one the users viewed the additional ephemeral content item. As additional users from the group messaging thread view the additional ephemeral content item and associated viewer devices send read receipts, the client device 106 optionally updates the additional administrative message indicating that additional users viewed the additional ephemeral content item.

In other words, the viewer device 114a, the networking system 102, and the client device 106 optionally perform acts similar to the acts 238-246 shown in FIG. 2B, except that the acts involve a group messaging thread and can include updating the additional administrative message to reflect additional views. Accordingly, although not shown in FIG. 3B, the viewer device 114a in FIG. 3B optionally presents the additional ephemeral content item and sends an additional read receipt to the networking system 102. The networking system 102 in turn optionally sends the additional read receipt to the client device 106. After receiving the additional read receipt, the client device 106 optionally opens the group messaging thread, determines that the user 118a viewed the additional ephemeral content item, and adds an additional administrative message to the group messaging.

Turning now to FIGS. 4A-4F, these figures generally illustrate the client device 106 adding administrative messages to a one-on-one messaging thread. As described below, FIGS. 4A-4F depict certain embodiments in which the client device 106 adds administrative messages to a messaging thread indicating a viewer's interaction with a user's ephemeral content item. By contrast, FIGS. 5A-5D generally illustrate the client device 106 adding or removing administrative messages to or from a group messaging thread indicating a viewer's interaction with a user's ephemeral content item.

As noted above, the networking application 108 comprises computer-executable instructions that cause the client device 106 to perform tasks depicted in FIGS. 4A-4F and 5A-5D. Rather than repeatedly describe the computer-executable instructions within the networking application 108 as causing the client device 106 to perform such tasks, this disclosure primarily describes the client device 106 as simply performing tasks as a shorthand for that relationship. Moreover, while this disclosure refers to touch gestures as examples of user interactions when describing 4A-4F and 5A-5D, in additional or alternative embodiments, the client device 106 detects any suitable user interaction, including a mouse click, stylus interaction, or a keyboard input.

As shown in FIG. 4A, the client device 106 presents an ephemeral-content menu 416 and a messaging inbox 418 within a graphical user interface 404 (“GUI 404”) of a touch screen 402. The GUI 404 represents a home screen that the client device 106 presents upon opening the networking application 108. Specifically, in response to the user 110 selecting a networking-application thumbnail (not shown) by touch gesture, the client device 106 initiates the networking application 108 and presents the GUI 404. As explained below, the GUI 404 includes selectable options that—when selected by the user 110—cause the client device 106 to capture ephemeral content items, view ephemeral content items, and open messaging threads.

As further shown within the GUI 404, the ephemeral-content menu 416 includes an add-content option 406. When the client device 106 detects a selection of the add-content option 406 by touch gesture, for instance, the client device 106 presents the user 110 with options to capture an ephemeral content item. For example, in some embodiments, in response to detecting a selection of the add-content option 406, the client device 106 presents a capture option (not shown) for capturing a digital image or a digital video using a camera 400 and a compilation-addition option (not shown) to add a captured digital image or digital video to the user 110's ephemeral content compilation. As shown in FIG. 4A, for example, the client device 106 presents a digital image of an ephemeral content item within a user's ephemeral-content thumbnail 408.

As suggested by FIG. 4A, the client device 106 sends the ephemeral content item captured by the camera 400 to the networking system 102 to add to the user 110's ephemeral content compilation. When the client device 106 receives an indication that the networking system 102 has added the ephemeral content item to the ephemeral content compilation, the client device 106 presents a digital image of the ephemeral content item within the user's ephemeral-content thumbnail 408. For example, in some embodiments, the client device 106 presents a single digital image from a video captured by the camera 400 within the user's ephemeral-content thumbnail 408 as a preview of the entire video.

As further suggested by FIG. 4A, the user's ephemeral-content thumbnail 408 not only includes a digital image of an ephemeral content item, but also a selectable option for presenting ephemeral content items within the user 110's ephemeral content compilation. When the client device 106 detects a selection from the user 110 of the user's ephemeral-content thumbnail 408, for example, the client device 106 presents the ephemeral content item previewed within the user's ephemeral-content thumbnail 408.

Consistent with the disclosure above, in some embodiments, an ephemeral content compilation includes multiple ephemeral content items. Accordingly, in certain embodiments, when the user 110's ephemeral content compilation includes multiple ephemeral content items—and the client device 106 detects a selection from the user 110 of the user's ephemeral-content thumbnail 408—the client device 106 presents each ephemeral content item within the user 110's ephemeral content compilation within the GUI 404.

As further shown in FIG. 4A, the ephemeral-content menu 416 also includes a contact's ephemeral-content thumbnail 410. In this embodiment, the contact represents a user with whom the user 110 is connected through the networking system 102 (e.g., as a friend or follower). Similar to the user's ephemeral-content thumbnail 408, the contact's ephemeral-content thumbnail 410 includes a digital image as a preview of an ephemeral content item captured by a contact of the user 110. The contact's ephemeral-content thumbnail 410 further includes a selectable option for presenting ephemeral content items within an ephemeral content compilation of the contact. When the client device 106 detects a selection from the user 110 of the contact's ephemeral-content thumbnail 410, the client device 106 presents the ephemeral content item previewed within the contact's ephemeral-content thumbnail 410 and, in some embodiments, any additional ephemeral content items within the contact's ephemeral content compilation.

In addition to the ephemeral-content menu 416 and its contents, the messaging inbox 418 includes various contents that facilitate viewing and adding to messaging threads. Specifically, the messaging inbox 418 includes messaging-thread previews 412a-412c. Each of the messaging-thread previews 412a-412c represent a messaging thread and provide a preview of its corresponding messaging thread. For example, the messaging-thread previews 412a and 412b both represent one-on-one messaging threads—with the messaging-thread preview 412a representing a messaging thread between the users 110 and 118a (the latter of whom FIG. 4A identifies as “Bob Potter”), and the messaging-thread preview 412b representing an additional messaging thread between the users 110 and 118b (the latter of whom FIG. 4A identifies as “Leslie Stone”). By contrast, the messaging-thread preview 412c represents a group messaging thread for the users 110, 118a, 118b, and 118n (the latter of whom FIG. 4A identifies as “Max Hart”).

Each of the messaging-thread previews 412a-412c likewise include a preview message from the corresponding messaging thread. Specifically, the messaging-thread preview 412a includes a preview message 414a, the messaging-thread preview 412b includes a preview message 414b, and the messaging-thread preview 412c includes a preview message 414c. The term “preview message” refers to a sample message from a messaging thread that provides a sampling of the messaging thread's contents. In some embodiments, the preview message comprises the message (or a portion of the message) last added to the messaging thread. For example, the preview message 414b comprises the message last added to a messaging thread between the users 110 and 118b.

In addition to preview messages, each of the messaging-thread previews 412a-412c also include a selectable option or a link that'when selected—causes the client device 106 to open a corresponding messaging thread within a graphical user interface. For example, when the client device 106 detects a selection from the user 110 of the messaging-thread preview 412b by touch gesture, for example, the client device 106 opens and presents the messaging thread corresponding to the messaging-thread preview 412b within the GUI 404. FIG. 4B illustrates an example of the corresponding messaging thread between the users 110 and 118b (hereinafter referred to as the “sample messaging thread”).

As shown in FIG. 4B, the client device 106 presents a messaging-thread display 419 within the GUI 404. The messaging-thread display 419 includes some (or all) messages sent and received within the sample messaging thread. Specifically, the messaging-thread display 419 includes a first message 420a from the user 118b and a second message 420b from the user 110. The messaging-thread display 419 also includes a first message timestamp 424a corresponding to the first message 420a indicating a time at which the viewer device 114b sent the first message 420a. The messaging-thread display 419 also includes a second message timestamp 424b corresponding to the second message 420b indicating a time at which the client device 106 sent the second message 420b.

Although not shown in FIG. 4B, the client device 106 also identifies a content-item timestamp indicating a time at which the networking system 102 adds an ephemeral content item to the user 110's ephemeral content compilation. Moreover, the client device 106 receives read receipts from various viewer devices—with each read receipt indicating that a different viewer viewed an ephemeral content item within the user 110's ephemeral content compilation. Each of these read receipts also comprises a read-receipt timestamp and a user identifier for the viewer who viewed the ephemeral content item.

Consistent with the disclosure above, after the client device 106 opens and presents the messaging thread shown in FIG. 4B, the client device 106 compares a user identifier for the user 118b to each of the user identifiers within the received read receipts. Upon determining that the user identifier for the user 118b matches one of the user identifiers within the received read receipts, the client device 106 determines that the read-receipt timestamp for the user 118b's read receipt occurs after the content-item timestamp. This timestamp comparison indicates that the user 118b viewed the last ephemeral content item added to the user 110's ephemeral content compilation. In response to determining that the read-receipt timestamp for the user 118b's read receipt occurs after the content-item timestamp, the client device 106 adds an administrative message 422 to the sample messaging thread.

As shown in FIG. 4B, the administrative message 422 indicates to the user 110 that the user 118b viewed the ephemeral content item previewed within the user's ephemeral-content thumbnail 408. Specifically, the administrative message 422 indicates that the user 118b viewed the ephemeral content item at a time indicated by an administrative timestamp 426. This administrative timestamp 426 corresponds to the read-receipt timestamp for the user 118b's read receipt. To reflect the time indicated by the administrative timestamp 426, the client device 106 adds the administrative message 422 in chronological order based on the time of the read-receipt timestamp for the user 118b's read receipt (or the administrative timestamp 426) relative to the times of the message timestamps 424a and 424b for the messages 420a and 420b, respectively.

As further shown in FIG. 4B, the client device 106 also presents an ephemeral-content menu 416a within the GUI 404. Similar to the ephemeral-content menu 416, the ephemeral-content menu 416a includes the user's ephemeral-content thumbnail 408, but the ephemeral-content menu 416a lacks the contact's ephemeral-content thumbnail 410. The ephemeral-content menu 416a further includes an add-content option 406a. When the client device 106 detects a selection of the add-content option 406a by touch gesture, for instance, the client device 106 presents the user 110 with options to capture an additional ephemeral content item and to add the additional ephemeral content item to the user 110's ephemeral content compilation.

But as noted above, in some embodiments, the client device 106 removes an administrative message in response to the networking system 102 adding an additional ephemeral content item to a user's ephemeral content compilation. FIG. 4C illustrates an example of such removal. As indicated by FIG. 4C, the client device 106 captures and sends an additional ephemeral content item to the networking system 102 to add to the user 110's ephemeral content compilation.

After the client device 106 sends (and the networking system 102 adds) the additional ephemeral content item, the client device 106 again opens the sample messaging thread and updates the user's ephemeral-content thumbnail 408. As shown in FIG. 4C, the ephemeral-content menu 416a includes an updated user's ephemeral-content thumbnail 408a—that is, an updated version of the user's ephemeral-content thumbnail 408. The updated user's ephemeral-content thumbnail 408a in turn includes an additional digital image as a preview of the additional ephemeral content item.

As further shown in FIG. 4C, after opening the sample messaging thread, the client device 106 removes the administrative message 422 and its corresponding administrative timestamp 426 from the messaging thread. Accordingly, the messaging-thread display 419 of FIG. 4C lacks both the administrative message 422 and the administrative timestamp 426. In some embodiments, the client device 106 again performs a read-receipt comparison before removing the administrative message 422.

To perform that read-receipt comparison, the client device 106 identifies an additional content-item timestamp indicating a time at which the networking system 102 adds the additional ephemeral content item to the user 110's ephemeral content compilation. The client device 106 then compares a user identifier for the user 118b to user identifiers within received read receipts. Upon determining that the user identifier for the user 118b matches a user identifier within one of the received read receipts, the client device 106 determines that the read-receipt timestamp for the user 118b's read receipt occurs before the additional content-item timestamp. This timestamp comparison indicates that the user 118b has not viewed the last ephemeral content item added to the user 110's ephemeral content compilation. In response to determining that the read-receipt timestamp for the user 118b's read receipt occurs before the additional content-item timestamp, the client device 106 removes the administrative message 422 and the administrative timestamp 426 from the messaging thread between users 110 and 118b.

After removing an administrative message, in some embodiments, the client device 106 adds an additional administrative message to a messaging thread upon receiving a new read receipt from a viewer associated with the messaging thread. FIG. 4D illustrates such an addition. As indicated by FIG. 4D, the client device 106 performs a similar comparison analysis as that explained above for adding an administrative message to the messaging thread. But in doing so, the client device 106 adds an additional administrative message based on an additional read receipt from the viewer device 114b.

In particular, the client device 106 receives an additional read receipt from the viewer device 114b indicating that the user 118b viewed the additional ephemeral content item. This additional read receipt includes a user identifier and an additional read-receipt timestamp indicating a time at which the user 118b viewed the additional ephemeral content item. The client device 106 also identifies an additional content-item timestamp indicating a time at which the networking system 102 adds the additional ephemeral content item to the user 110's ephemeral content compilation. Upon identifying the additional content-item timestamp—and after again opening the sample messaging thread—the client device 106 compares a user identifier for the user 118b to user identifiers within received read receipts, including the user identifier within the additional read receipt.

Based on this comparison, the client device 106 determines that the user identifier for the user 118b matches the user identifier within the additional read receipt. The client device 106 further determines that the additional read-receipt timestamp for the additional read receipt occurs after the additional content-item timestamp. Similar to the timestamp comparison above for FIG. 4B, this timestamp comparison indicates that the user 118b viewed the last ephemeral content item added to the user 110's ephemeral content compilation. In response to determining that the additional read-receipt timestamp occurs after the additional content-item timestamp, the client device 106 adds an additional administrative message 428 to the messaging thread.

As shown in FIG. 4D, the additional administrative message 428 indicates to the user 110 that the user 118b viewed the additional ephemeral content item previewed within the updated user's ephemeral-content thumbnail 408a. Specifically, the additional administrative message 428 indicates that the user 118b viewed the additional ephemeral content at a time indicated by an additional administrative timestamp 429.

As also noted above, in some embodiments, the client device 106 removes an administrative message—and adds a responsive administrative message—in response to receiving a message responding to an ephemeral content item. When adding a message responding to the ephemeral content item, the client device 106 sometimes removes the administrative message indicating a viewer viewed the ephemeral content item because the message responding to the ephemeral content item implies the viewer viewed the item. FIG. 4E illustrates an example of such removal and addition of administrative messages.

As shown in FIG. 4E, the client device 106 receives a message 434 from the user 118b responding to the additional ephemeral content item. The message 434 in turn refers to an ephemeral-content thumbnail 432 that depicts the additional ephemeral content item. Specifically, the message 434 refers to the ephemeral-content thumbnail 432 with an edge of the message 434's bubble conforming to the lower boundary of the ephemeral-content thumbnail 432. In additional or alternative embodiments, a message responding to an ephemeral content item refers to an ephemeral-content thumbnail by, for example, overlaying the message on an ephemeral-content thumbnail, aligning the message on the ephemeral-content thumbnail, or embedding the message within the ephemeral-content thumbnail.

Receipt of the message 434 triggers the client device 106 to perform at least a couple acts. First, after opening the sample messaging thread, the client device 106 removes the additional administrative message 428 from the messaging thread. As shown in FIG. 4E, the messaging-thread display 419 lacks the additional administrative message 428 and its corresponding additional administrative timestamp 429. Second, the client device 106 adds a responsive administrative message 430 to the messaging thread. As shown in FIG. 4E, the responsive administrative message 430 indicates to the user 110 that the user 118b responded to the additional ephemeral content item at a time indicated by a responsive administrative timestamp 431.

Similar to the message 434, the responsive administrative message 430 also refers to the ephemeral-content thumbnail 432. As shown in FIG. 4E, the client device 106 positions the responsive administrative message 430 above the ephemeral-content thumbnail 432 within the messaging-thread display 419 to indicate that the responsive administrative message 430 refers to the ephemeral-content thumbnail 432. In additional or alternative embodiments, a responsive administrative message refers to an ephemeral-content thumbnail in other ways, including, but not limited to, overlaying the responsive administrative message on an ephemeral-content thumbnail, aligning the responsive administrative message on the ephemeral-content thumbnail, or embedding the responsive administrative message within the ephemeral-content thumbnail.

In the embodiments described above with reference to FIGS. 4B-4D, the client device 106 adds or removes administrative messages upon opening a messaging thread. But in certain embodiments, the client device 106 adds or removes administrative messages to or from a messaging thread independent of whether a messaging thread is opened. In addition to adding or removing an administrative message independent of opening a messaging thread, in some embodiments, the client device 106 relocates a messaging thread within a messaging inbox or updates a preview message of the messaging thread in response to adding an administrative message. FIG. 4F illustrates an example of such relocating and updating.

As shown in FIG. 4F, the client device 106 again presents the messaging inbox 418 within the GUI 404. In contrast to when the client device 106 presents the GUI 404 as shown in FIG. 4A, however, the client device 106 receives the additional read receipt indicating that the user 118b viewed the additional ephemeral content item. Consistent with the disclosure above, the client device 106 subsequently adds the additional administrative message 428 to the sample messaging thread—but independent of opening the messaging thread.

In addition to adding the additional administrative message 428, the client device 106 updates the messaging inbox 418. Specifically, the client device 106 relocates the messaging-thread preview 412b within the messaging inbox 418. As shown in FIG. 4F, the client device 106 relocates the messaging-thread preview 412b above the messaging-thread preview 412a such that the messaging-thread preview 412a and the messaging-thread preview 412b switch positions. Upon relocating the messaging-thread preview 412b, the client device 106 orders the messaging-thread previews 412a-412c in chronological order by ordering first the messaging-thread preview corresponding to the messaging thread having the most recently received message (i.e., the messaging-thread preview 412b) and ordering last the messaging-thread preview corresponding to the messaging thread having the least recently received message (i.e., the messaging-thread preview 412c).

The client device 106 also updates the preview message 414b for the messaging-thread preview 412b to reflect the additional administrative message 428. As shown in FIG. 4F, the preview message 414b indicates that the user 118b viewed the additional ephemeral content item. By contrast, the preview message 414a and the preview message 414c remain unchanged.

Turning back now to FIGS. 5A-5D, these figures generally illustrate the client device 106 adding or removing administrative messages to or from a group messaging thread. As shown in FIG. 5A, the client device 106 opens a group messaging thread for the users 110, 118a, 118b, and 118n (hereinafter referred to as the “sample group messaging thread”). After opening the sample group messaging thread, the client device 106 presents a messaging-thread display 518 within a graphical user interface 504 (“GUI 504”) of a touch screen 502. The messaging-thread display 518 includes some or all messages sent and received within the sample group messaging thread. As shown in FIG. 4B, the messaging-thread display 518 includes a first group message 510a from the user 118n, a second group message 510b from the user 110, and a third group message 510c from the user 118a.

As further shown in FIG. 5A, a first message timestamp 512a corresponds to the first group message 510a and indicates a time at which the viewer device 114n sent the first group message 510a. Similarly, a second message timestamp 512b corresponds to the second group message 510b and indicates a time at which the client device 106 sent the second group message 510b. Likewise, a third message timestamp 512c corresponds to the third group message 510c and indicates a time at which the viewer device 114a sent the third group message 510c.

As further shown in FIG. 5A, the client device 106 further presents an ephemeral-content menu 508 within the GUI 504. The ephemeral-content menu 508 includes a user's ephemeral-content thumbnail 506. The user's ephemeral-content thumbnail 506 includes a digital image (and preview) of an ephemeral content item added to the user 110's ephemeral content compilation. As above, the client device 106 identifies a content-item timestamp indicating a time at which the networking system 102 adds the ephemeral content item to the user 110's ephemeral content compilation. Accordingly, the ephemeral-content menu 508 and the user's ephemeral-content thumbnail 506 are similar to (and function the same as) the ephemeral-content menu 416a and the user's ephemeral-content thumbnail 408 shown in FIG. 4B.

Consistent with the disclosure above, after the client device 106 opens and presents the sample group messaging thread shown in FIG. 5A, the client device 106 compares user identifiers for each of the users 118a, 118b, and 118n to each of the user identifiers within received read receipts. The client device 106 then determines that the user identifier for the user 118a matches one of the user identifiers within the received read receipts. By contrast, at the point shown in FIG. 5A, the client device 106 determines that the user identifiers for the users 118b and 118n do not match user identifiers within the received read receipts.

After identifying a matching user identifier for the user 118a, the client device 106 determines that the read-receipt timestamp for the user 118a's read receipt occurs after the content-item timestamp for the ephemeral content item previewed within the user's ephemeral-content thumbnail 506. This timestamp comparison indicates that the user 118a viewed the last ephemeral content item added to the user 110's ephemeral content compilation. In response to determining that the read-receipt timestamp for the user 118a's read receipt occurs after the content-item timestamp, the client device 106 adds an administrative message 514 to the sample group messaging thread. As shown in FIG. 5B, the administrative message 514 indicates to the user 110 that the user 118a viewed the ephemeral content item previewed within the user's ephemeral-content thumbnail 506 at a time indicated by an administrative timestamp 516.

As noted above, in some embodiments, the client device 106 updates an administrative message—after receiving an additional read receipt for a user within a group messaging thread—to reflect that an additional user viewed an ephemeral content item. FIG. 5B illustrates the client device 106 updating an administrative message. As suggested by FIG. 5B, the client device 106 performs a similar analysis as that done before adding the administrative message 514. Consistent with the disclosure above, the client device 106 opens the sample group messaging thread and determines that it has received a read receipt for the user 118n. The client device 106 then determines that the read-receipt timestamp for the user 118n's read receipt occurs after the content-item timestamp for the ephemeral content item previewed within the user's ephemeral-content thumbnail 506.

As shown in FIG. 5B, based on the timestamp comparison, the client device 106 updates the administrative message 514 to become an updated administrative message 514a. The updated administrative message 514a indicates to the user 110 that both the users 118a and 118n viewed the ephemeral content item previewed within the user's ephemeral-content thumbnail 506. An updated administrative timestamp 516a indicates a time at which the users 118a and 118n viewed the ephemeral content item. While the user 118a viewed the ephemeral content item at an earlier time—as indicated by the administrative timestamp 516—the updated administrative timestamp 516a corresponds to the read-receipt timestamp within the user 118n's read receipt. Accordingly, the updated administrative timestamp 516a indicates that both the users 118a and 118n viewed the ephemeral content item by the time shown in the updated administrative timestamp 516a. The updated administrative timestamp 516a does not, however, indicate that both the users 118a and 118n viewed the ephemeral content item at the time shown in the updated administrative timestamp 516a.

Alternatively, in some embodiments, the client device 106 updates administrative messages in different ways. For example, in some embodiments, the client device 106 updates an administrative message by adding a separate entry and separate administrative timestamp for two or more users. Such entries indicate that the users viewed the ephemeral content item at different times. In other embodiments, the client device 106 updates an administrative message by listing users who viewed an ephemeral content item, but without an administrative timestamp. The client device 106 nevertheless may update an administrative message to appear in chronological order relative to the other messages.

In addition to such updates, in some embodiments, the client device 106 further updates an administrative message—and adds a responsive administrative message to a group messaging thread—in response to receiving a message responding to an ephemeral content item. When adding a message responding to the ephemeral content item, the client device 106 sometimes further updates an administrative message indicating multiple viewers viewed the ephemeral content item because the message responding to the ephemeral content item implies one of the viewers viewed the item. FIG. 5C illustrates an example of such further updating and addition of administrative messages.

As shown in FIG. 5C, the client device 106 receives a message 526 from the user 118a responding to the ephemeral content item previewed within the user's ephemeral-content thumbnail 506. Consistent with the disclosure above, the message 526 in turn refers to an ephemeral-content thumbnail 524 that depicts the ephemeral content item. Specifically, the message 526 refers to the ephemeral-content thumbnail 524 with an edge of the message 526's bubble conforming to the lower boundary of the ephemeral-content thumbnail 524.

Receipt of the message 526 triggers the client device 106 to perform at least a couple acts. First, after opening the sample group messaging thread, the client device 106 further updates the updated administrative message 514a to become an updated administrative message 514b. The updated administrative message 514b indicates that the user 118n, but not the user 118a, viewed the ephemeral content item at a time indicated by an updated administrative timestamp 516b. In other words, the client device 106 removes reference to the user 118a from the updated administrative message 514a to create the updated administrative message 514b.

Second, the client device 106 adds a responsive administrative message 522 to the sample group messaging thread. As shown in FIG. 5C, the responsive administrative message 522 indicates to the user 110 that the user 118a responded to the ephemeral content item previewed within the user's ephemeral-content thumbnail 506 at a time indicated by a responsive administrative timestamp 520. Similar to the message 526, the responsive administrative message 522 also refers to the ephemeral-content thumbnail 524. As shown in FIG. 5C, the client device 106 positions the responsive administrative message 522 above the ephemeral-content thumbnail 524 to indicate that the responsive administrative message 522 refers to the ephemeral-content thumbnail 524.

As further shown in FIG. 5C, after receiving and adding the message 526, the client device 106 adds an additional administrative message 530 to the sample group messaging thread. In doing so, the client device 106 performs a similar analysis as that done before adding the administrative message 514. Consistent with the disclosure above, the client device 106 opens the sample group messaging thread and determines that it has received an additional read receipt for the user 118b. The client device 106 then determines that an additional read-receipt timestamp for the additional read receipt occurs after the content-item timestamp for the ephemeral content item previewed within the user's ephemeral-content thumbnail 506. Based on that determination, the client device 106 adds the additional administrative message 530 indicating that the user 118b viewed the ephemeral content item at a time indicated by an additional administrative timestamp 528.

In addition to adding a responsive administrative message and additional administrative messages, in some embodiments, the removal of an ephemeral content item from an ephemeral content compilation triggers the client device 106 to remove an administrative message and an ephemeral-content thumbnail from a messaging thread. In such embodiments, the networking application 108 causes the client device 106 to remove evidence of the ephemeral content item from a messaging thread after the ephemeral content item is itself removed. FIG. 5D illustrates an example of such removal.

As shown in FIG. 5D, the client device 106 determines (or receives an indication from the networking system 102) that the ephemeral content item previewed within the user's ephemeral-content thumbnail 506 has been removed. Based on that determination (or indication), the client device 106 removes the updated administrative message 514b and the updated administrative timestamp 516b from the sample group messaging thread. Based on that same determination (or same indication), the client device 106 also removes the ephemeral-content thumbnail 524 from the sample group messaging thread. Accordingly, the messaging-thread display 518 in FIG. 5D lacks the updated administrative message 514b, updated administrative timestamp 516b, and the ephemeral-content thumbnail 524.

As indicated by FIG. 5D, however, the client device 106 captures and sends an additional ephemeral content item to the networking system 102 to add to the user 110's ephemeral content compilation. After the client device 106 sends (and the networking system 102 adds) the additional ephemeral content item, the client device 106 again opens the sample group messaging thread and updates the user's ephemeral-content thumbnail 506. As shown in FIG. 5D, the ephemeral-content menu 508 includes an updated user's ephemeral-content thumbnail 506a—that is, an updated version of the user's ephemeral-content thumbnail 506. The updated user's ephemeral-content thumbnail 506a in turn includes an additional digital image as a preview of the additional ephemeral content item.

As further shown in FIG. 5D, after opening the sample group messaging thread, the client device 106 adds an additional administrative message 534 to the sample group messaging thread. In doing so, the client device 106 performs a similar analysis as that done before adding the additional administrative message 530 described above. Consistent with the disclosure above, the client device 106 opens the sample group messaging thread and determines that it has received an additional read receipt for the user 118b. The client device 106 then determines that an additional read-receipt timestamp for the additional read receipt occurs after the content-item timestamp for the additional ephemeral content item previewed within the user's ephemeral-content thumbnail 506a. Based on that determination, the client device 106 adds the additional administrative message 534 indicating that the user 118b viewed the additional ephemeral content item at a time indicated by an additional administrative timestamp 532.

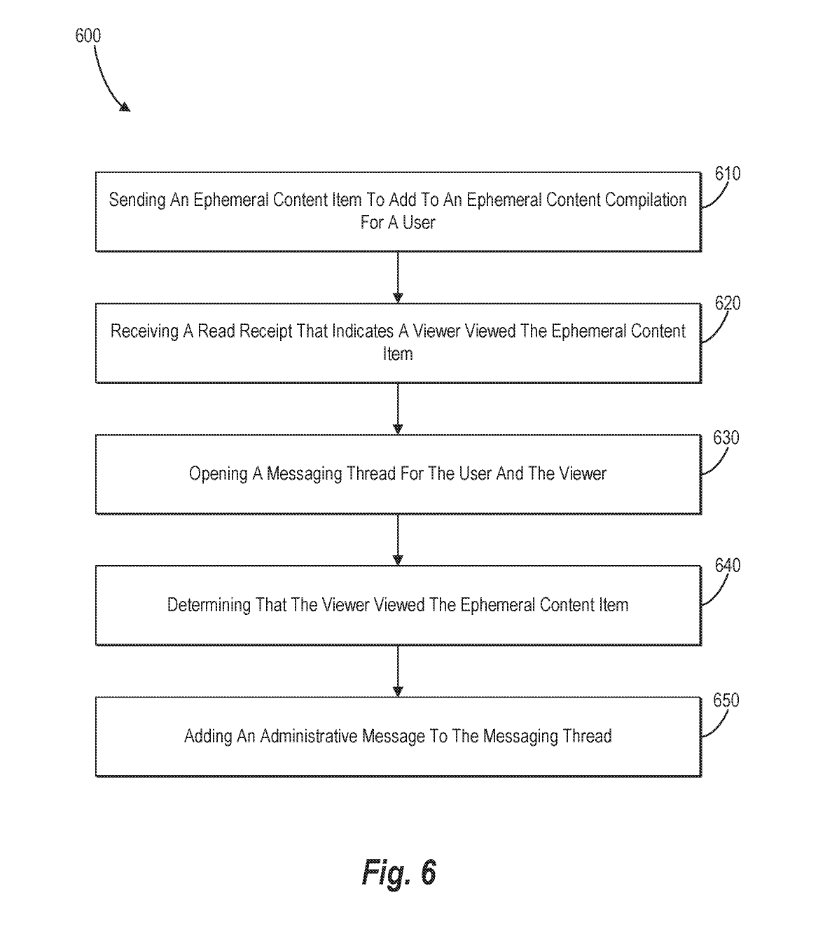

Turning now to FIG. 6, this figure illustrates a flowchart of a series of acts 600 of providing an administrative message within a messaging thread indicating to a user that a viewer viewed the user's ephemeral content item in accordance with one or more embodiments. While FIG. 6 illustrates acts according to one embodiment, alternative embodiments may omit, add to, reorder, and/or modify any of the acts shown in FIG. 6. The acts of FIG. 6 can be performed as part of a method. Alternatively, a non-transitory computer readable storage medium can comprise instructions that, when executed by one or more processors, cause a computing device to perform the acts depicted in FIG. 6. In still further embodiments, a system can perform the acts of FIG. 6.

As shown in FIG. 6, the acts 600 include an act 610 of sending an ephemeral content item to add to an ephemeral content compilation for a user. In particular, in some embodiments, the act 610 includes sending, from a client device to a networking system, an ephemeral content item to add to an ephemeral content compilation for a user.

As further shown in FIG. 6, the acts 600 include an act 620 of receiving a read receipt that indicates a viewer viewed the ephemeral content item. In particular, in some embodiments, the act 620 includes receiving, from the networking system, a read receipt that indicates a viewer viewed the ephemeral content item. In some such embodiments, the read receipt comprises a read-receipt timestamp indicating a time at which the viewer viewed the ephemeral content item.

As further shown in FIG. 6, the acts 600 include an act 630 of opening a messaging thread for the user and the viewer. In particular, in some embodiments, the act 630 includes opening, by the client device, a messaging thread between the user and the viewer.

As further shown in FIG. 6, the acts 600 include an act 640 of determining that the viewer viewed the ephemeral content item. In particular, in some embodiments, the act 640 includes, based on the read receipt, determining, by the client device, that the viewer viewed the ephemeral content item. For example, in some embodiments, determining that the viewer viewed the ephemeral content item is in response to opening the messaging thread. By contrast, in some embodiments, determining that the viewer viewed the ephemeral content item is independent of opening the messaging thread.

As further shown in FIG. 6, the acts 600 include an act 650 of adding an administrative message to the messaging thread. In particular, in some embodiments, the act 650 includes, in response to determining that the viewer viewed the ephemeral content item, adding an administrative message to the messaging thread, the administrative message indicating to the user that the viewer viewed the ephemeral content item. For example, in certain embodiments, adding the administrative message to the messaging thread comprises adding the administrative message in a chronological order based on the time of the read-receipt timestamp relative to times of timestamps for messages within the messaging thread.

In addition to the acts 610-650, in some embodiments, the acts 600 further include identifying a content-item timestamp indicating a time at which the networking system added the ephemeral content item to the ephemeral content compilation; determining that the read-receipt timestamp is after the content-item timestamp; and wherein adding the administrative message to the messaging thread comprises adding the administrative message to the messaging thread in response to determining that the read-receipt timestamp is after the content-item timestamp.

Additionally, in some embodiments, the acts 600 further include removing the administrative message from the messaging thread in response to: the networking system adding an additional ephemeral content item to the ephemeral content compilation; the viewer sending a message to the user responding to the ephemeral content item; or an expiration of the ephemeral content item.

Relatedly, in some embodiments, the acts 600 further include receiving, by the client device, a message from the viewer responding to the ephemeral content item; based on receipt of the message: removing the administrative message from the messaging thread; and adding a responsive administrative message to the messaging thread, the responsive administrative message indicating to the user that the viewer responded to the ephemeral content item. In some such embodiments, the acts 600 further include receiving a notice that the networking system has removed the ephemeral content item from the ephemeral content compilation after a display period for the ephemeral content item has lapsed; and maintaining the responsive administrative message within the messaging thread.

By contrast, in some embodiment the acts 600 further include sending, from the client device to the networking system, an additional ephemeral content item to add to the ephemeral content compilation for the user; based on sending the additional ephemeral content item, removing the administrative message from the messaging thread; receiving, from the networking system, an additional read receipt that indicates the viewer viewed the additional ephemeral content item; opening, by the client device, the messaging thread between the user and the viewer; based on the additional read receipt, determining, by the client device, that the viewer viewed the additional ephemeral content item; and in response to determining that the viewer viewed the additional ephemeral content item, adding an additional administrative message to the messaging thread, the additional administrative message indicating to the user that the viewer viewed the additional ephemeral content item.

Moreover, the acts 600 further include receiving, from the networking system, a plurality of read receipts that indicate a plurality of viewers viewed the ephemeral content item, the plurality of read receipts comprising the read receipt and each of the plurality of read receipts comprising a user identifier for a corresponding viewer of the plurality of viewers; wherein determining that the viewer viewed the ephemeral content item comprises comparing a first user identifier for the viewer to each of the user identifiers within the plurality of read receipts; and determining that a user identifier within the read receipt matches the first user identifier for the viewer.

As suggested above, in some embodiments, the acts 600 involve updating a messaging inbox. For example, in certain embodiments, the acts 600 further include, in response to adding the administrative message to the messaging thread, relocating the messaging thread within a messaging inbox. As another example, in certain embodiments, the acts 600 further include, in response to adding the administrative message to the messaging thread, updating a preview message for the messaging thread to include the administrative message.

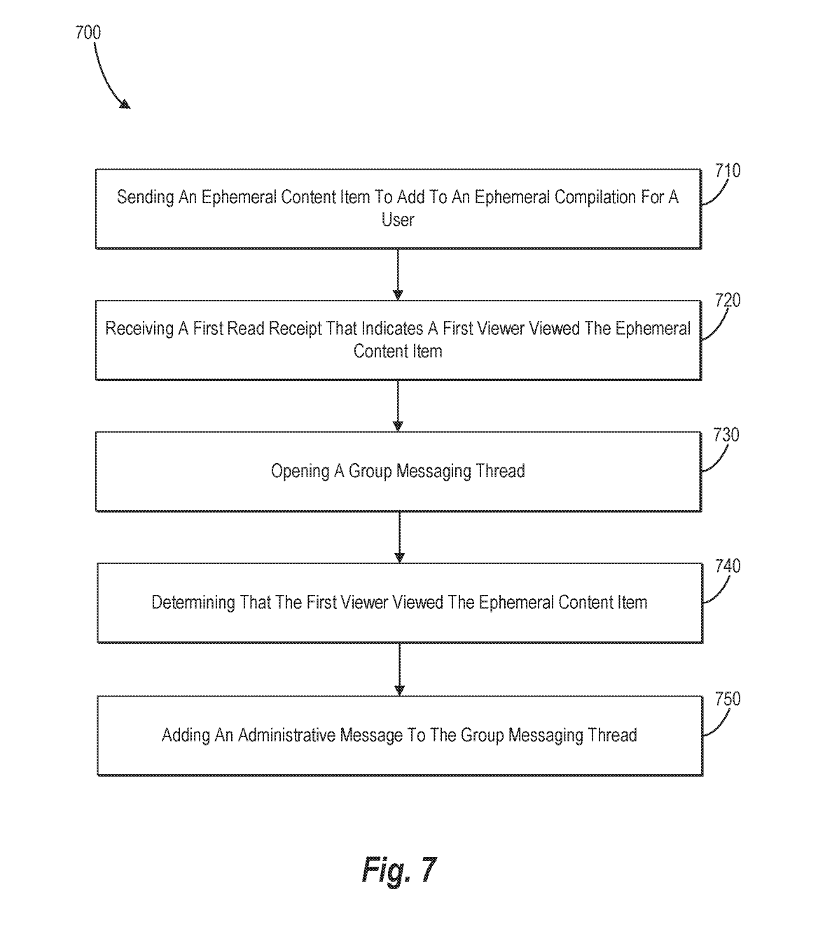

Turning now to FIG. 7, this figure illustrates a flowchart of a series of acts 700 of providing an administrative message within a group messaging thread indicating to a user that a viewer viewed the user's ephemeral content item in accordance with one or more embodiments. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer readable storage medium can comprise instructions that, when executed by one or more processors, cause a computing device to perform the acts depicted in FIG. 7. In still further embodiments, a system can perform the acts of FIG. 7.

As shown in FIG. 7, the acts 700 include an act 710 of sending an ephemeral content item to add to an ephemeral content compilation for a user. In particular, in some embodiments, the act 710 includes sending, from a client device to a networking system, an ephemeral content item to add to an ephemeral content compilation for a user.

As further shown in FIG. 7, the acts 700 include an act 720 of receiving a first read receipt that indicates a first viewer viewed the ephemeral content item. In particular, in some embodiments, the act 720 includes receiving, from the networking system, a first read receipt that indicates a first viewer viewed the ephemeral content item. In some such embodiments, the first read receipt comprises a first read-receipt timestamp indicating a time at which the first viewer viewed the ephemeral content item.

As further shown in FIG. 7, the acts 700 include an act 730 of opening a group messaging thread. In particular, in some embodiments, the act 730 includes opening, by the client device, a group messaging thread for the user, the first viewer, and a second viewer.

As further shown in FIG. 7, the acts 700 include an act 740 of determining that the first viewer viewed the ephemeral content item. In particular, in some embodiments, the act 740 includes, based on the first read receipt, determining, by the client device, that the first viewer viewed the ephemeral content item. For example, in some embodiments, determining that the first viewer viewed the ephemeral content item is in response to opening the group messaging thread. By contrast, in some embodiments, determining that the first viewer viewed the ephemeral content item is independent of opening the group messaging thread.

As further shown in FIG. 7, the acts 700 include an act 750 of adding an administrative message to the group messaging thread. In particular, in some embodiments, the act 750 includes, in response to determining that the first viewer viewed the ephemeral content item, adding an administrative message to the group messaging thread, the administrative message indicating to the user that the first viewer viewed the ephemeral content item. For example, in certain embodiments, adding the administrative message to the group messaging thread comprises adding the administrative message in a chronological order based on the time of the first read-receipt timestamp relative to times of timestamps for messages within the group messaging thread.

In addition to the acts 710-750, in some embodiments, the acts 700 further include receiving, from the networking system, a plurality of read receipts that indicate a plurality of viewers viewed the ephemeral content item, the plurality of read receipts comprising the first read receipt and each of the plurality of read receipts comprising a user identifier for a corresponding viewer of the plurality of viewers; wherein determining that the first viewer viewed the ephemeral content item comprises: comparing a first user identifier for the first viewer to each of the user identifiers within the plurality of read receipts; and determining that a user identifier within the first read receipt matches the first user identifier for the first viewer.

Additionally, in some embodiments, the acts 700 further include receiving, from the networking system, a second read receipt that indicates the second viewer viewed the ephemeral content item; opening, by the client device, the group messaging thread; based on the second read receipt, determining, by the client device, that the second viewer viewed the ephemeral content item; and in response to determining that the second viewer viewed the ephemeral content item, updating the administrative message to indicate to the user that the second viewer also viewed the ephemeral content item.

Moreover, in certain embodiments, the acts 700 further include after adding the administrative message to the group messaging thread, receiving a message for the group messaging thread; after receiving the message, receiving, from the networking system, a second read receipt that indicates the second viewer viewed the ephemeral content item; after receiving the second read receipt, opening, by the client device, the group messaging thread; based on the second read receipt, determining, by the client device, that the second viewer viewed the ephemeral content item; and in response to determining that the second viewer viewed the ephemeral content item, adding an additional administrative message to the group messaging thread, the additional administrative message indicating to the user that the second viewer viewed the ephemeral content item.

Relatedly, in some embodiments, adding the additional administrative message to the group messaging thread comprises presenting the administrative message followed by the message and the message followed by the additional administrative message within a graphical user interface for the group messaging thread.

Finally, in some embodiments, the acts 700 further include, before adding the administrative message to the group messaging thread, sending, from the client device to the networking system, an additional ephemeral content item to add to the ephemeral content compilation for the user; receiving, from the networking system, a second read receipt that indicates the first viewer viewed the additional ephemeral content item; after opening the group messaging thread, determining, by the client device, that the first viewer viewed the additional ephemeral content item based on the additional read receipt; and wherein adding the administrative message to the group messaging thread comprises, in response to determining that the first viewer viewed the ephemeral content item and the additional ephemeral content item, adding the administrative message to the group messaging thread, the administrative message indicating to the user that the first viewer viewed the ephemeral content item and the additional ephemeral content item.

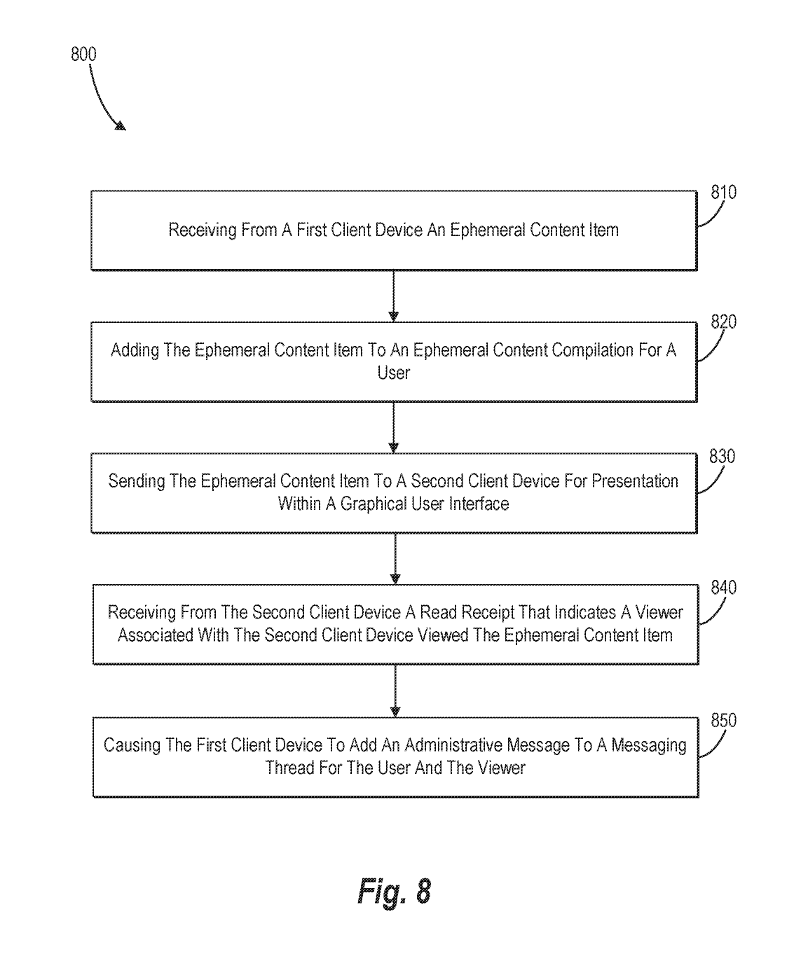

Turning now to FIG. 8, this figure illustrates a flowchart of a series of acts 800 of causing a client device to add an administrative message to a messaging thread indicating to a user that a viewer viewed the user's ephemeral content item in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer readable storage medium can comprise instructions that, when executed by one or more processors, cause a computing device to perform the acts depicted in FIG. 8. In still further embodiments, a system can perform the acts of FIG. 8.

As shown in FIG. 8, the acts 800 include an act 810 of receiving from a first client device an ephemeral content item, an act 820 of adding the ephemeral content item to an ephemeral content compilation for a user, an act 830 of sending the ephemeral content item to a second client device for presentation within a graphical user interface, and an act 840 of receiving from the second client device a read receipt that indicates a viewer associated with the second client device viewed the ephemeral content item.

As further shown in FIG. 8, the acts 800 include an act 850 of causing the first client device to add an administrative message to a messaging thread for the user and the viewer. In particular, in some embodiments, the act 850 includes, in response to receiving the read receipt, causing the first client device to add an administrative message to a messaging thread for the user and the viewer, the administrative message indicating to the user that the viewer viewed the ephemeral content item. For example, in some embodiments, causing the first client device to add the administrative message to the messaging thread comprises sending the read receipt to the first client device to cause the first client device to add the administrative message to the messaging thread after opening the messaging thread.

In addition to the acts 810-850, in some embodiments, the acts 800 further include receiving, from the first client device, an additional ephemeral content item; adding the additional ephemeral content item to the ephemeral content compilation for the user; sending the additional ephemeral content item to the second client device for presentation within the graphical user interface; and based on sending the additional ephemeral content item to the second client device, causing the first client device to remove the administrative message from the messaging thread.

Relatedly, in some embodiments, the acts 800 further include receiving, from the second client device, an additional read receipt that indicates the viewer associated with the second client device viewed the additional ephemeral content item; and, in response to receiving the additional read receipt, causing the first client device to add an additional administrative message to the messaging thread, the additional administrative message indicating to the user that the viewer viewed the additional ephemeral content item.

Moreover, in some embodiments, the acts 800 further include receiving, from the second client device, a message responding to the ephemeral content item; sending the message to the first client device; based on receipt of the message: causing the first client device to remove the administrative message from the messaging thread; and causing the first client device to add a responsive administrative message to the messaging thread, the responsive administrative message indicating to the user that the viewer responded to the ephemeral content item.

Turning now to FIG. 9, this figure illustrates a flowchart of a series of acts 900 of causing a client device to add an administrative message to a group messaging thread indicating to a user that a viewer viewed the user's ephemeral content item in accordance with one or more embodiments. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer readable storage medium can comprise instructions that, when executed by one or more processors, cause a computing device to perform the acts depicted in FIG. 9. In still further embodiments, a system can perform the acts of FIG. 9.

As shown in FIG. 9, the acts 900 include an act 910 of receiving from a first client device an ephemeral content item, an act 920 of adding the ephemeral content item to an ephemeral content compilation for a user, an act 930 of sending the ephemeral content item to a second client device for presentation within a graphical user interface, and an act 940 of receiving from the second client device a first read receipt that indicates a first viewer associated with the second client device viewed the ephemeral content item.

As further shown in FIG. 9, the acts 900 include an act 950 of causing the first client device to add an administrative message to a group messaging thread for the user, the first viewer, and a second viewer. In particular, in some embodiments, the act 950 includes, in response to receiving the first read receipt, causing the first client device to add an administrative message to a group messaging thread for the user, the first viewer, and a second viewer, the administrative message indicating to the user that the first viewer viewed the ephemeral content item.

In addition to the acts 910-950, in some embodiments, the acts 900 further include receiving, from a third client device, a second read receipt that indicates the second viewer associated with the third client device viewed the ephemeral content item; and in response to receiving the second read receipt, causing the first client device to update the administrative message to indicate to the user that the second viewer also viewed the ephemeral content item.

Additionally, in some embodiments, the acts 900 further include after adding the administrative message to the group messaging thread, receiving a message for the group messaging thread; receiving, from a third client device, a second read receipt that indicates the second viewer associated with the third client device viewed the ephemeral content item; and, in response to receiving the second read receipt, causing the first client device to add an additional administrative message to the group messaging thread, the additional administrative message indicating to the user that the second viewer also viewed the ephemeral content item.

Moreover, in some embodiments, the acts 900 further include before adding the administrative message to the group messaging thread, receiving, from the first client device, an additional ephemeral content item; adding the additional ephemeral content item to the ephemeral content compilation for the user; and receiving, from a third client device, a second read receipt that indicates that the first viewer viewed the additional ephemeral content item; wherein causing the client device to add the administrative message to the group messaging thread comprises, in response to receiving the second read receipt, causing the first client device to add the administrative message to the group messaging thread, the administrative message indicating to the user that the first viewer viewed the ephemeral content item and the additional ephemeral content item.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of exemplary computing device 1000 that may be configured to perform one or more of the processes described above. One will appreciate that one or more computing devices such as the computing device 1000 may implement the networking system 102. As shown by FIG. 10, the computing device 1000 can comprise a processor 1002, a memory 1004, a storage device 1006, an I/O interface 1008, and a communication interface 1010, which may be communicatively coupled by way of a communication infrastructure 1012. While an exemplary computing device 1000 is shown in FIG. 10, the components illustrated in FIG. 10 are not intended to be limiting. Additional or alternative components may be used in other embodiments. Furthermore, in certain embodiments, the computing device 1000 can include fewer components than those shown in FIG. 10. Components of the computing device 1000 shown in FIG. 10 will now be described in additional detail.

In one or more embodiments, the processor 1002 includes hardware for executing instructions, such as those making up a computer program. As an example and not by way of limitation, to execute instructions, the processor 1002 may retrieve (or fetch) the instructions from an internal register, an internal cache, the memory 1004, or the storage device 1006 and decode and execute them. In one or more embodiments, the processor 1002 may include one or more internal caches for data, instructions, or addresses. As an example and not by way of limitation, the processor 1002 may include one or more instruction caches, one or more data caches, and one or more translation lookaside buffers (“TLBs”). Instructions in the instruction caches may be copies of instructions in the memory 1004 or the storage device 1006.

The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1004 may be internal or distributed memory.

The storage device 1006 includes storage for storing data or instructions. As an example and not by way of limitation, storage device 1006 can comprise a non-transitory storage medium described above. The storage device 1006 may include a hard disk drive (“HDD”), flash memory, an optical disc, a magneto-optical disc, magnetic tape, or a Universal Serial Bus (“USB”) drive or a combination of two or more of these. The storage device 1006 may include removable or non-removable (or fixed) media, where appropriate. The storage device 1006 may be internal or external to the computing device 1000. In one or more embodiments, the storage device 1006 is non-volatile, solid-state memory. In other embodiments, the storage device 1006 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

The I/O interface 1008 allows a user to provide input to, receive output from, and otherwise transfer data to and receive data from computing device 1000. The I/O interface 1008 may include a mouse, a keypad or a keyboard, a touchscreen, a camera, an optical scanner, network interface, modem, other known I/O devices or a combination of such I/O interfaces. The I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1008 is configured to provide graphical data to a display for presentation to a user. The graphical data may be representative of one or more graphical user interfaces and/or any other graphical content as may serve a particular implementation.

The communication interface 1010 can include hardware, software, or both. In any event, the communication interface 1010 can provide one or more interfaces for communication (such as, for example, packet-based communication) between the computing device 1000 and one or more other computing devices or networks. As an example and not by way of limitation, the communication interface 1010 may include a network interface controller (“NIC”) or network adapter for communicating with an Ethernet or other wire-based network or a wireless NIC (“WNIC”) or wireless adapter for communicating with a wireless network, such as a WI-FI.

Additionally, or alternatively, the communication interface 1010 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, the communication interface 1010 may facilitate communications with a wireless PAN (“WPAN”) (such as, for example, a BLUETOOTH WPAN), a WI-FI network, a WI-MAX network, a cellular telephone network (such as, for example, a Global System for Mobile Communications (“GSM”) network), or other suitable wireless network or a combination thereof.

Additionally, the communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 1012 may include hardware, software, or both that couples components of the computing device 1000 to each other. As an example and not by way of limitation, the communication infrastructure 1012 may include an Accelerated Graphics Port (“AGP”) or other graphics bus, an Enhanced Industry Standard Architecture (“EISA”) bus, a front-side bus (“FSB”), a HYPERTRANSPORT (“HT”) interconnect, an Industry Standard Architecture (“ISA”) bus, an INFINIBAND interconnect, a low-pin-count (“LPC”) bus, a memory bus, a Micro Channel Architecture (“MCA”) bus, a Peripheral Component Interconnect (“PCI”) bus, a PCI-Express (“PCIe”) bus, a serial advanced technology attachment (“SATA”) bus, a Video Electronics Standards Association local (“VLB”) bus, or another suitable bus or a combination thereof.

A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, on-line calendars and event organization, messaging, games, or advertisements) to facilitate social interaction between or among users. Also, the social-networking system may allow users to post photographs and other multimedia content items to a user's profile page (typically known as “wall posts” or “timeline posts”) or in a photo album, both of which may be accessible to other users of the social-networking system depending upon the user's configured privacy settings.

FIG. 11 illustrates an example network environment 1100 of a networking system. Network environment 1100 includes a client device 1106, a networking system 1102, and a third-party system 1108 connected to each other by a network 1104. Although FIG. 11 illustrates a particular arrangement of client device 1106, networking system 1102, third-party system 1108, and network 1104, this disclosure contemplates any suitable arrangement of client device 1106, networking system 1102, third-party system 1108, and network 1104. As an example and not by way of limitation, two or more of client device 1106, networking system 1102, and third-party system 1108 may be connected to each other directly, bypassing network 1104. As another example, two or more of client device 1106, networking system 1102, and third-party system 1108 may be physically or logically co-located with each other in whole or in part. Moreover, although FIG. 11 illustrates a particular number of client devices 1106, networking systems 1102, third-party system 1108, and networks 1104, this disclosure contemplates any suitable number of client devices 1106, networking systems 1102, third-party system 1108, and networks 1104. As an example and not by way of limitation, network environment 1100 may include multiple client devices 1106, networking systems 1102, third-party system 1108, and networks 1104.

This disclosure contemplates any suitable network 1104. As an example and not by way of limitation, one or more portions of network 1104 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1104 may include one or more networks 1104.

Links may connect client device 1106, networking system 1102, and third-party system 1108 to communication network 1104 or to each other. This disclosure contemplates any suitable links. In particular embodiments, one or more links include one or more wireline (such as for example Digital Subscriber Line (“DSL”) or Data Over Cable Service Interface Specification (“DOCSIS”)), wireless (such as for example Wi-Fi or Worldwide Interoperability for Microwave Access (“WiMAX”)), or optical (such as for example Synchronous Optical Network (“SONET”) or Synchronous Digital Hierarchy (“SDH”)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1100. One or more first links may differ in one or more respects from one or more second links.

In particular embodiments, client device 1106 may be an electronic device including hardware, software, or embedded logic components or a combination of two or more such components and capable of carrying out the appropriate functionalities implemented or supported by client device 1106. As an example and not by way of limitation, a client device 1106 may include any of the computing devices discussed above in relation to FIG. 11. A client device 1106 may enable a network user at client device 1106 to access network 1104. A client device 1106 may enable its user to communicate with other users at other client devices 1106.

In particular embodiments, client device 1106 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client device 1106 may enter a Uniform Resource Locator (“URL”) or other address directing the web browser to a particular server (such as server, or a server associated with a third-party system 1108), and the web browser may generate a Hyper Text Transfer Protocol (“HTTP”) request and communicate the HTTP request to server. The server may accept the HTTP request and communicate to client device 1106 one or more Hyper Text Markup Language (“HTML”) files responsive to the HTTP request. Client device 1106 may render a webpage based on the HTML files from the server for presentation to the user. This disclosure contemplates any suitable webpage files. As an example and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, networking system 1102 may be a network-addressable computing system that can host an online social network. Networking system 1102 may generate, store, receive, and send social-networking data, such as, for example, user-profile data, concept-profile data, social-graph information, or other suitable data related to the online social network. Networking system 1102 may be accessed by the other components of network environment 1100 either directly or via network 1104. In particular embodiments, networking system 1102 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, networking system 1102 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1106, a networking system 1102, or a third-party system 1108 to manage, retrieve, modify, add, or delete, the information stored in data store.

In particular embodiments, networking system 1102 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Networking system 1102 may provide users of the online social network the ability to communicate and interact with other users. In particular embodiments, users may join the online social network via networking system 1102 and then add connections (e.g., relationships) to a number of other users of networking system 1102 whom they want to be connected to. Herein, the term “friend” may refer to any other user of networking system 1102 with whom a user has formed a connection, association, or relationship via networking system 1102.

In particular embodiments, networking system 1102 may provide users with the ability to take actions on various types of items or objects, supported by networking system 1102. As an example and not by way of limitation, the items and objects may include groups or social networks to which users of networking system 1102 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in networking system 1102 or by an external system of third-party system 1108, which is separate from networking system 1102 and coupled to networking system 1102 via a network 1104.

In particular embodiments, networking system 1102 may be capable of linking a variety of entities. As an example and not by way of limitation, networking system 1102 may enable users to interact with each other as well as receive content from third-party system 1108 or other entities, or to allow users to interact with these entities through an application programming interfaces (“API”) or other communication channels.

In particular embodiments, a third-party system 1108 may include one or more types of servers, one or more data stores, one or more interfaces, including but not limited to APIs, one or more web services, one or more content sources, one or more networks, or any other suitable components, e.g., that servers may communicate with. A third-party system 1108 may be operated by a different entity from an entity operating networking system 1102. In particular embodiments, however, networking system 1102 and third-party system 1108 may operate in conjunction with each other to provide social-networking services to users of networking system 1102 or third-party system 1108. In this sense, networking system 1102 may provide a platform, or backbone, which other systems, such as third-party system 1108, may use to provide social-networking services and functionality to users across the Internet.

In particular embodiments, a third-party system 1108 may include a third-party content object provider. A third-party content object provider may include one or more sources of content objects, which may be communicated to a client device 1106. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, networking system 1102 also includes user-generated content objects, which may enhance a user's interactions with networking system 1102. User-generated content may include anything a user can add, upload, send, or “post” to networking system 1102. As an example and not by way of limitation, a user communicates posts to networking system 1102 from a client device 1106. Posts may include data such as status updates or other textual data, location information, photos, videos, links, music or other similar data or media. Content may also be added to networking system 1102 by a third-party through a “communication channel,” such as a newsfeed or stream.

In particular embodiments, networking system 1102 may include a variety of servers, sub-systems, programs, modules, logs, and data stores. In particular embodiments, networking system 1102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Networking system 1102 may also include suitable components such as network interfaces, security mechanisms, load balancers, failover servers, management-and-network-operations consoles, other suitable components, or any suitable combination thereof. In particular embodiments, networking system 1102 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking networking system 1102 to one or more client devices 1106 or one or more third-party system 1108 via network 1104. The web server may include a mail server or other messaging functionality for receiving and routing messages between networking system 1102 and one or more client devices 1106. An API-request server may allow a third-party system 1108 to access information from networking system 1102 by calling one or more APIs. An action logger may be used to receive communications from a web server about a user's actions on or off networking system 1102. In conjunction with the action log, a third-party-content-object log may be maintained of user exposures to third-party-content objects. A notification controller may provide information regarding content objects to a client device 1106. Information may be pushed to a client device 1106 as notifications, or information may be pulled from client device 1106 responsive to a request received from client device 1106. Authorization servers may be used to enforce one or more privacy settings of the users of networking system 1102. A privacy setting of a user determines how particular information associated with a user can be shared. The authorization server may allow users to opt in to or opt out of having their actions logged by networking system 1102 or shared with other systems (e.g., third-party system 1108), such as, for example, by setting appropriate privacy settings. Third-party-content-object stores may be used to store content objects received from third parties, such as a third-party system 1108. Location stores may be used for storing location information received from client devices 1106 associated with users. Advertisement-pricing modules may combine social information, the current time, location information, or other suitable information to provide relevant advertisements, in the form of notifications, to a user.

FIG. 12 illustrates example social graph 1200. In particular embodiments, networking system 1102 may store one or more social graphs 1200 in one or more data stores. In particular embodiments, social graph 1200 may include multiple nodes—which may include multiple user nodes 1202 or multiple concept nodes 1204—and multiple edges 1206 connecting the nodes. Example social graph 1200 illustrated in FIG. 12 is shown, for didactic purposes, in a two-dimensional visual map representation. In particular embodiments, a networking system 1102, client device 1106, or third-party system 1108 may access social graph 1200 and related social-graph information for suitable applications. The nodes and edges of social graph 1200 may be stored as data objects, for example, in a data store (such as a social-graph database). Such a data store may include one or more searchable or query able indexes of nodes or edges of social graph 1200.

In particular embodiments, a user node 1202 may correspond to a user of networking system 1102. As an example and not by way of limitation, a user may be an individual (human user), an entity (e.g., an enterprise, business, or third-party application), or a group (e.g., of individuals or entities) that interacts or communicates with or over networking system 1102. In particular embodiments, when a user registers for an account with networking system 1102, networking system 1102 may create a user node 1202 corresponding to the user, and store the user node 1202 in one or more data stores. Users and user nodes 1202 described herein may, where appropriate, refer to registered users and user nodes 1202 associated with registered users. In addition, or as an alternative, users and user nodes 1202 described herein may, where appropriate, refer to users that have not registered with networking system 1102. In particular embodiments, a user node 1202 may be associated with information provided by a user or information gathered by various systems, including networking system 1102. As an example and not by way of limitation, a user may provide his or her name, profile picture, contact information, birth date, sex, marital status, family status, employment, education background, preferences, interests, or other demographic information. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

In particular embodiments, a concept node 1204 may correspond to a concept. As an example and not by way of limitation, a concept may correspond to a place (such as, for example, a movie theater, restaurant, landmark, or city); a website (such as, for example, a website associated with networking system 1102 or a third-party website associated with a web-application server); an entity (such as, for example, a person, business, group, sports team, or celebrity); a resource (such as, for example, an audio file, video file, digital photo, text file, structured document, or application) which may be located within networking system 1102 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 1204 may be associated with information of a concept provided by a user or information gathered by various systems, including networking system 1102. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 1204 may be associated with one or more data objects corresponding to information associated with concept nodes 1204. In particular embodiments, a concept node 1204 may correspond to one or more webpages.

In particular embodiments, a node in social graph 1200 may represent or be represented by a webpage (which may be referred to as a “profile page”). Profile pages may be hosted by or accessible to networking system 1102. Profile pages may also be hosted on third-party websites associated with a third-party system 1108. As an example and not by way of limitation, a profile page corresponding to a particular external webpage may be the particular external webpage and the profile page may correspond to a particular concept node 1204. Profile pages may be viewable by all or a selected subset of other users. As an example and not by way of limitation, a user node 1202 may have a corresponding user-profile page in which the corresponding user may add content, make declarations, or otherwise express himself or herself. As another example and not by way of limitation, a concept node 1204 may have a corresponding concept-profile page in which one or more users may add content, make declarations, or express themselves, particularly in relation to the concept corresponding to concept nodes 1204.

In particular embodiments, a concept node 1204 may represent a third-party webpage or resource hosted by a third-party system 1108. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client device 1106 to send to networking system 1102 a message indicating the user's action. In response to the message, networking system 1102 may create an edge (e.g., an “eat” edge) between a user node 1202 corresponding to the user and a concept node 1204 corresponding to the third-party webpage or resource and store edge 1206 in one or more data stores.

In particular embodiments, a pair of nodes in social graph 1200 may be connected to each other by one or more edges 1206. An edge 1206 connecting a pair of nodes may represent a relationship between the pair of nodes. In particular embodiments, an edge 1206 may include or represent one or more data objects or attributes corresponding to the relationship between a pair of nodes. As an example and not by way of limitation, a first user may indicate that a second user is a “friend” of the first user. In response to this indication, networking system 1102 may send a “friend request” to the second user. If the second user confirms the “friend request,” networking system 1102 may create an edge 1206 connecting the first user's user node 1202 to the second user's user node 1202 in social graph 1200 and store edge 1206 as social-graph information in one or more of data stores. In the example of FIG. 12, social graph 1200 includes an edge 1206 indicating a friend relation between user nodes 1202 of user “A” and user “B” and an edge indicating a friend relation between user nodes 1202 of user “C” and user “B.” Although this disclosure describes or illustrates particular edges 1206 with particular attributes connecting particular user nodes 1202, this disclosure contemplates any suitable edges 1206 with any suitable attributes connecting user nodes 1202. As an example and not by way of limitation, an edge 1206 may represent a friendship, family relationship, business or employment relationship, fan relationship, follower relationship, visitor relationship, sub scriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 1200 by one or more edges 1206.

In particular embodiments, an edge 1206 between a user node 1202 and a concept node 1204 may represent a particular action or activity performed by a user associated with user node 1202 toward a concept associated with a concept node 1204. As an example and not by way of limitation, as illustrated in FIG. 12, a user may “like,” “attended,” “played,” “listened,” “cooked,” “worked at,” or “watched” a concept, each of which may correspond to an edge type or subtype. A concept-profile page corresponding to a concept node 1204 may include, for example, a selectable “check in” icon (such as, for example, a clickable “check in” icon) or a selectable “add to favorites” icon. Similarly, after a user clicks these icons, networking system 1102 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, networking system 1102 may create a “listened” edge 1206 and a “used” edge (as illustrated in FIG. 12) between user nodes 1202 corresponding to the user and concept nodes 1204 corresponding to the song and application to indicate that the user listened to the song and used the application. Moreover, networking system 1102 may create a “played” edge 1206 (as illustrated in FIG. 12) between concept nodes 1204 corresponding to the song and the application to indicate that the particular song was played by the particular application. In this case, “played” edge 1206 corresponds to an action performed by an external application (SPOTIFY) on an external audio file (the song “Imagine”). Although this disclosure describes particular edges 1206 with particular attributes connecting user nodes 1202 and concept nodes 1204, this disclosure contemplates any suitable edges 1206 with any suitable attributes connecting user nodes 1202 and concept nodes 1204. Moreover, although this disclosure describes edges between a user node 1202 and a concept node 1204 representing a single relationship, this disclosure contemplates edges between a user node 1202 and a concept node 1204 representing one or more relationships. As an example and not by way of limitation, an edge 1206 may represent both that a user likes and has used at a particular concept. Alternatively, another edge 1206 may represent each type of relationship (or multiples of a single relationship) between a user node 1202 and a concept node 1204 (as illustrated in FIG. 12 between user node 1202 for user “E” and concept nodes 1204 for “SPOTIFY”).

In particular embodiments, networking system 1102 may create an edge 1206 between a user node 1202 and a concept node 1204 in social graph 1200. As an example and not by way of limitation, a user viewing a concept-profile page (such as, for example, by using a web browser or a special-purpose application hosted by the user's client device 1106) may indicate that he or she likes the concept represented by the concept nodes 1204 by clicking or selecting a “Like” icon, which may cause the user's client device 1106 to send to networking system 1102 a message indicating the user's liking of the concept associated with the concept-profile page. In response to the message, networking system 1102 may create an edge 1206 between user node 1202 associated with the user and concept nodes 1204, as illustrated by “like” edge 1206 between the user and concept nodes 1204. In particular embodiments, networking system 1102 may store an edge 1206 in one or more data stores. In particular embodiments, an edge 1206 may be automatically formed by networking system 1102 in response to a particular user action. As an example and not by way of limitation, if a first user uploads a picture, watches a movie, or listens to a song, an edge 1206 may be formed between user node 1202 corresponding to the first user and concept nodes 1204 corresponding to those concepts. Although this disclosure describes forming particular edges 1206 in particular manners, this disclosure contemplates forming any suitable edges 1206 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition, or as an alternative, an advertisement may be one or more sponsored stories (e.g., a news-feed or ticker item on networking system 1102). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, networking system 1102 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through networking system 1102) or RSVP (e.g., through networking system 1102) to an event associated with the advertisement. In addition or as an alternative, an advertisement may include social-networking-system context directed to the user. As an example and not by way of limitation, an advertisement may display information about a friend of the user within networking system 1102 who has taken an action associated with the subject matter of the advertisement.

In particular embodiments, networking system 1102 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party system 1108 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, networking system 1102 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part based on the history of the user's actions. Coefficients may be used to predict any number of actions, which may be within or outside of the online social network. As an example and not by way of limitation, these actions may include various types of communications, such as sending messages, posting content, or commenting on content; various types of an observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, networking system 1102 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the networking system 1102 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, networking system 1102 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, networking system 1102 may calculate a coefficient based on a user's actions. Networking system 1102 may monitor such actions on the online social network, on a third-party system 1108, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, networking system 1102 may calculate a coefficient based on the user's actions with particular types of content. The content may be associated with the online social network, a third-party system 1108, or another suitable system. The content may include users, profile pages, posts, news stories, headlines, instant messages, chat room conversations, emails, advertisements, pictures, video, music, other suitable objects, or any combination thereof. Networking system 1102 may analyze a user's actions to determine whether one or more of the actions indicate an affinity for subject matter, content, other users, and so forth. As an example and not by way of limitation, if a user may make frequently posts content related to “coffee” or variants thereof, networking system 1102 may determine the user has a high coefficient with respect to the concept “coffee.” Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, networking system 1102 may calculate a coefficient based on the type of relationship between particular objects. Referencing the social graph 1200, networking system 1102 may analyze the number and/or type of edges 1206 connecting particular user nodes 1202 and concept nodes 1204 when calculating a coefficient. As an example and not by way of limitation, user nodes 1202 that are connected by a spouse-type edge (representing that the two users are married) may be assigned a higher coefficient than user nodes 1202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, networking system 1102 may determine that the user has a higher coefficient with respect to the first photo than the second photo because having a tagged-in-type relationship with content may be assigned a higher weight and/or rating than having a like-type relationship with content. In particular embodiments, networking system 1102 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, networking system 1102 may determine that the first user should also have a relatively high coefficient for the particular object. In particular embodiments, the coefficient may be based on the degree of separation between particular objects. Degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 1200. As an example and not by way of limitation, social-graph entities that are closer in the social graph 1200 (i.e., fewer degrees of separation) may have a higher coefficient than entities that are further apart in the social graph 1200.

In particular embodiments, networking system 1102 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client device 1106 of the user). A first user may be more interested in other users or concepts that are closer to the first user. As an example and not by way of limitation, if a user is one mile from an airport and two miles from a gas station, networking system 1102 may determine that the user has a higher coefficient for the airport than the gas station based on the proximity of the airport to the user.

In particular embodiments, networking system 1102 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, networking system 1102 may provide information that is relevant to user's interests and current circumstances, increasing the likelihood that they will find such information of interest. In particular embodiments, networking system 1102 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, networking system 1102 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, networking system 1102 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 1108 (e.g., via an API or other communication channel), or from another suitable system. In response to the request, networking system 1102 may calculate the coefficient (or access the coefficient information if it has previously been calculated and stored). In particular embodiments, networking system 1102 may measure an affinity with respect to a particular process. Different processes (both internal and external to the online social network) may request a coefficient for a particular object or set of objects. Networking system 1102 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or acts disclosed in U.S. patent application Ser. No. 11/503,093, filed 11 Aug. 2006, U.S. patent application Ser. No. 12/978,027, filed 22 Dec. 2010, U.S. patent application Ser. No. 12/978,265, filed 23 Dec. 2010, and U.S. patent application Ser. No. 13/642,869, filed 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 1204 corresponding to a particular photo may have a privacy setting specifying that the photo may only be accessed by users tagged in the photo and their friends. In particular embodiments, privacy settings may allow users to opt in or opt out of having their actions logged by networking system 1102 or shared with other systems (e.g., third-party system 1108). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party system 1108, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, networking system 1102 may send a request to the data store for the object. The request may identify the user associated with the request and may only be sent to the user (or a client device 1106 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes that come within the meaning and range of equivalency of the claims are to be embraced within their scope.

We claim:

1. A non-transitory computer readable medium storing instructions thereon that, when executed by at least one processor, cause a client device to:
send to a networking system an ephemeral content item to add to an ephemeral content compilation for a user;
receive from the networking system a read receipt that indicates a viewer viewed the ephemeral content item;
open a messaging thread for the user and the viewer;
based on the read receipt, determine that the viewer viewed the ephemeral content item; and
in response to determining that the viewer viewed the ephemeral content item, add an administrative message to the messaging thread, the administrative message indicating to the user that the viewer viewed the ephemeral content item.

2. The non-transitory computer readable medium of claim 1, wherein:
the instructions that cause the client device to receive from the networking system the read receipt that indicates the viewer viewed the ephemeral content item comprises instructions that, when executed by the at least one processor, cause the client device to receive the read receipt comprising a read-receipt timestamp indicating a time at which the viewer viewed the ephemeral content item;
the instructions that cause the client device to add the administrative message to the messaging thread comprise instructions that, when executed by the at least one processor, cause the client device to:
identify a content-item timestamp indicating a time at which the networking system added the ephemeral content item to the ephemeral content compilation;
determine that the read-receipt timestamp is after the content-item timestamp; and
add the administrative message to the messaging thread in response to determining that the read-receipt timestamp is after the content-item timestamp.

3. The non-transitory computer readable medium of claim 1, further comprising instructions that, when executed by the at least one processor, cause the client device to remove the administrative message from the messaging thread in response to:
the networking system adding an additional ephemeral content item to the ephemeral content compilation;
the viewer sending a message to the user responding to the ephemeral content item; or an expiration of the ephemeral content item.

4. The non-transitory computer readable medium of claim 1, further comprising instructions that, when executed by the at least one processor, cause the client device to:
receive a message from the viewer responding to the ephemeral content item;
based on receipt of the message:
remove the administrative message from the messaging thread; and
add a responsive administrative message to the messaging thread, the responsive administrative message indicating to the user that the viewer responded to the ephemeral content item.

5. The non-transitory computer readable medium of claim 1, further comprising instructions that, when executed by the at least one processor, cause the client device to:
send to the networking system an additional ephemeral content item to add to the ephemeral content compilation for the user;
based on sending the additional ephemeral content item, remove the administrative message from the messaging thread;
receive from the networking system an additional read receipt that indicates the viewer viewed the additional ephemeral content item;
open the messaging thread for the user and the viewer;
based on the additional read receipt, determine that the viewer viewed the additional ephemeral content item; and
in response to determining that the viewer viewed the additional ephemeral content item, add an additional administrative message to the messaging thread, the additional administrative message indicating to the user that the viewer viewed the additional ephemeral content item.

6. The non-transitory computer readable medium of claim 1, further comprising instructions that, when executed by the at least one processor, cause the client device to:
receive a message from the viewer responding to the ephemeral content item;
based on receipt of the message:
remove the administrative message from the messaging thread; and
add a responsive administrative message to the messaging thread, the responsive administrative message indicating to the user that the viewer responded to the ephemeral content item;
receive a notice that the networking system has removed the ephemeral content item from the ephemeral content compilation after a display period for the ephemeral content item has lapsed; and
maintain the responsive administrative message within the messaging thread.

7. The non-transitory computer readable medium of claim 1, wherein the instructions that cause the client device to open the messaging thread for the user and the viewer include instructions that, when executed by the at least one processor, cause the client device to open a group messaging thread for the user, the viewer, and an additional viewer.

8. The non-transitory computer readable medium of claim 7, further comprising instructions that, when executed by the at least one processor, cause the client device to receive from the networking system a plurality of read receipts that indicate a plurality of viewers viewed the ephemeral content item, the plurality of read receipts comprising the read receipt and each of the plurality of read receipts comprising a user identifier for a corresponding viewer of the plurality of viewers;
wherein the instructions that cause the client device to determine that the viewer viewed the ephemeral content item comprise instructions that cause the client device to:
compare a first user identifier for the viewer to each of the user identifiers within the plurality of read receipts; and
determine that a user identifier within the read receipt matches the first user identifier for the viewer.

9. The non-transitory computer readable medium of claim 7, further comprising instructions that, when executed by the at least one processor, cause the client device to:
receive from the networking system an additional read receipt that indicates the additional viewer viewed the ephemeral content item;
open the group messaging thread;
based on the additional read receipt, determine that the additional viewer viewed the ephemeral content item; and
in response to determining that the additional viewer viewed the ephemeral content item, update the administrative message to indicate to the user that the additional viewer also viewed the ephemeral content item.

10. The non-transitory computer readable medium of claim 7, further comprising instructions that, when executed by the at least one processor, cause the client device to:
after adding the administrative message to the group messaging thread, receive a message for the group messaging thread;
after receiving the message, receive from the networking system an additional read receipt that indicates the additional viewer viewed the ephemeral content item;
after receiving the additional read receipt, open the group messaging thread;
based on the additional read receipt, determine that the additional viewer viewed the ephemeral content item; and
in response to determining that the additional viewer viewed the ephemeral content item, add an additional administrative message to the group messaging thread, the additional administrative message indicating to the user that the additional viewer viewed the ephemeral content item.

11. The non-transitory computer readable medium of claim 7, further comprising instructions that, when executed by the at least one processor, cause the client device to:
before adding the administrative message to the group messaging thread, send to the networking system an additional ephemeral content item to add to the ephemeral content compilation for the user;
receive from the networking system an additional read receipt that indicates the viewer viewed the additional ephemeral content item;
after opening the group messaging thread, determine that the viewer viewed the additional ephemeral content item based on the additional read receipt; and
wherein the instructions that cause the client device to add the administrative message to the group messaging thread comprise instructions that, when executed by the at least one processor cause the client device to, in response to determining that the viewer viewed the ephemeral content item and the additional ephemeral content item, add the administrative message to the messaging thread, the administrative message indicating to the user that the viewer viewed the ephemeral content item and the additional ephemeral content item.

12. A system comprising:
at least one processor; and
at least one non-transitory computer readable storage medium storing instructions that, when executed by the at least one processor, cause the system to:
receive, from a first client device, an ephemeral content item;
add the ephemeral content item to an ephemeral content compilation for a user;
send the ephemeral content item to a second client device for presentation within a graphical user interface;
receive, from the second client device, a read receipt that indicates a viewer associated with the second client device viewed the ephemeral content item; and
in response to receiving the read receipt, cause the first client device to add an administrative message to a messaging thread for the user and the viewer, the administrative message indicating to the user that the viewer viewed the ephemeral content item.

13. The system of claim 12, wherein the instructions that cause the first client device to add the administrative message to the messaging thread for the user and the viewer comprise instructions that, when executed by the at least one processor, cause the system to send the read receipt to the first client device to cause the first client device to add the administrative message to the messaging thread after opening the messaging thread.

14. The system of claim 12, further comprising instructions that, when executed by the at least one processor, cause the system to:
receive, from the first client device, an additional ephemeral content item;
add the additional ephemeral content item to the ephemeral content compilation for the user;
send the additional ephemeral content item to the second client device for presentation within the graphical user interface; and
based on sending the additional ephemeral content item to the second client device, cause the first client device to remove the administrative message from the messaging thread.

15. The system of claim 14, further comprising instructions that, when executed by the at least one processor, cause the system to:
receive, from the second client device, an additional read receipt that indicates the viewer associated with the second client device viewed the additional ephemeral content item; and
in response to receiving the additional read receipt, cause the first client device to add an additional administrative message to the messaging thread, the additional administrative message indicating to the user that the viewer viewed the additional ephemeral content item.

16. The system of claim 12, further comprising instructions that, when executed by the at least one processor, cause the system to:
receive, from the second client device, a message responding to the ephemeral content item;
send the message to the first client device;
based on receipt of the message:
cause the first client device to remove the administrative message from the messaging thread; and
cause the first client device to add a responsive administrative message to the messaging thread, the responsive administrative message indicating to the user that the viewer responded to the ephemeral content item.

17. A method comprising:
receiving, from a first client device, an ephemeral content item;
adding the ephemeral content item to an ephemeral content compilation for a user;
sending the ephemeral content item to a second client device for presentation within a graphical user interface;
receiving, from the second client device, a first read receipt that indicates a first viewer associated with the second client device viewed the ephemeral content item; and
in response to receiving the first read receipt, causing the first client device to add an administrative message to a group messaging thread for the user, the first viewer, and the second viewer, the administrative message indicating to the user that the first viewer viewed the ephemeral content item.

18. The method of claim 17, further comprising:
receiving, from a third client device, a second read receipt that indicates the second viewer associated with the third client device viewed the ephemeral content item; and
in response to receiving the second read receipt, causing the first client device to update the administrative message to indicate to the user that the second viewer also viewed the ephemeral content item.

19. The method of claim 17, further comprising:
after adding the administrative message to the group messaging thread, receiving a message for the group messaging thread;
receiving, from a third client device, a second read receipt that indicates the second viewer associated with the third client device viewed the ephemeral content item; and
in response to receiving the second read receipt, causing the first client device to add an additional administrative message to the group messaging thread, the additional administrative message indicating to the user that the second viewer also viewed the ephemeral content item.

20. The method of claim 17, further comprising:
before adding the administrative message to the group messaging thread, receiving, from the first client device, an additional ephemeral content item;
adding the additional ephemeral content item to the ephemeral content compilation for the user; and
receiving, from a third client device, a second read receipt that indicates that the first viewer viewed the additional ephemeral content item;
wherein causing the client device to add the administrative message to the group messaging thread comprises, in response to receiving the second read receipt, causing the first client device to add the administrative message to the group messaging thread, the administrative message indicating to the user that the first viewer viewed the ephemeral content item and the additional ephemeral content item.
